(19) United States
(12) Patent Application Publication
(10) Pub. No.: US 2025/0269844 A1
(43) Pub. Date: Aug. 28, 2025

(54) PARKING ASSISTANCE DEVICE AND PARKING ASSISTANCE METHOD

(71) Applicant: Panasonic Automotive Systems Co., Ltd., Kanagawa (JP)

(72) Inventors: Yoshimasa OKABE, Kanagawa Ken (JP); Hirofumi NISHIMURA, Kanagawa Ken (JP)

(73) Assignee: Panasonic Automotive Systems Co., Ltd., Kanagawa (JP)

(21) Appl. No.: 19/029,738

(22) Filed: Jan. 17, 2025

(30) Foreign Application Priority Data
Feb. 22, 2024 (JP) 2024-025510

(51) Int. Cl. B60W 30/06; B60W 50/14; B60W 50/16

(52) U.S. Cl. CPC B60W 30/06; B60W 50/14; B60W 50/16; B60W 2520/06; B60W 2540/227; B60W 2555/20; B60W 2556/10

(57) ABSTRACT

A parking assistance device is configured to automatically park a vehicle at a predetermined parking position. The parking assistance device includes a memory, and a processor coupled to the memory. The processor is configured to: store a parking route to the parking position; perform detection at least around the vehicle to obtain detection information; control traveling in automatic parking; make a notification to an occupant of the vehicle; and suspend, based on at least one of the detection information and a motion of the occupant, the traveling in the automatic parking. The processor is configured to: suspend the traveling in the automatic parking in at least one of a case in which the processor detects an obstacle interfering during the automatic parking and a case in which the occupant stops the vehicle, and make a notification as to suspension of the traveling of the automatic parking, to the occupant.

### CROSS-REFERENCE TO RELATED APPLICATIONS

This application is based upon and claims the benefit of priority from Japanese Patent Application No. 2024-025510, filed on Feb. 22, 2024, the entire contents of which are incorporated herein by reference.

### FIELD

The present disclosure relates to a parking assistance device and a parking assistance method.

### BACKGROUND

Conventionally, there is known a technique of automatically operating a brake and stopping automatic parking when an obstacle at a short distance from a vehicle is detected during automatic parking. In such a case, in the conventional technique, even if an occupant of the vehicle goes out of the vehicle to clear the obstacle and then returns to the vehicle, automatic parking cannot be resumed, resulting in inconvenience to the occupant.

A related technique is described in JP 2021-160476 A.

An object of the present disclosure is to provide a parking assistance device having improved convenience.

### SUMMARY

In order to solve the above problem, A parking assistance device is configured to automatically park a vehicle at a predetermined parking position. The parking assistance device includes a memory, and a processor coupled to the memory. The processor is configured to: store a parking route to the parking position; perform detection at least around the vehicle to obtain detection information; control traveling in automatic parking; make a notification to an occupant of the vehicle; and suspend, based on at least one of the detection information and a motion of the occupant, the traveling in the automatic parking. The processor is configured to: suspend the traveling in the automatic parking in at least one of a case in which the processor detects an obstacle interfering during the automatic parking and a case in which the occupant stops the vehicle, and make a notification as to suspension of the traveling of the automatic parking, to the occupant.

### BRIEF DESCRIPTION OF THE DRAWINGS

FIG. 1 is a diagram illustrating an example of a vehicle to which a parking assistance ECU according to an embodiment is applicable;

FIG. 2 is a block diagram illustrating an example of a hardware configuration of the parking assistance ECU according to the embodiment;

FIG. 3 is a block diagram illustrating an example of a configuration of a parking assistance system according to the embodiment;

FIG. 4 is a diagram illustrating an example of processing in which a space recognition unit according to the embodiment specifies a position of a feature point;

FIG. 5 is a diagram illustrating an example of a getting-off obstruction range according to the embodiment;

FIG. 6 is a diagram illustrating an example of the getting-off obstruction range according to the embodiment;

FIG. 7 is a diagram illustrating an example of a parking obstruction range according to the embodiment;

FIG. 8 is a diagram illustrating an example of the getting-off obstruction range and the parking obstruction range according to the embodiment;

FIG. 9 is a diagram illustrating an example of assistance in clearing an obstacle at a position where interference is not caused according to the embodiment;

FIG. 10 is a diagram illustrating an example of assistance in clearing the obstacle at the position where interference is not caused according to the embodiment;

FIG. 11 is a diagram illustrating an example of a notification as to a range where interference is not caused according to the embodiment;

FIG. 12 is a diagram illustrating an example of the notification as to the range where interference is not caused according to the embodiment;

FIG. 13 is a diagram illustrating an example of a notification as to whether or not interference is caused according to the embodiment;

FIG. 14 is a diagram illustrating an example of the notification as to whether or not interference is caused according to the embodiment;

FIG. 15 is a diagram illustrating an example of assistance in stopping a vehicle at a suitable position at which an interfering obstacle is cleared according to the embodiment;

FIG. 16 is a flowchart illustrating an example of processing executed by the parking assistance ECU according to the embodiment;

FIG. 17 is a diagram illustrating an example of automatic parking by the parking assistance ECU according to the embodiment;

FIG. 18 is a diagram illustrating an example of the automatic parking by the parking assistance ECU according to the embodiment;

FIG. 19 is a diagram illustrating an example of the automatic parking by the parking assistance ECU according to the embodiment;

FIG. 20 is a diagram illustrating an example of the automatic parking by the parking assistance ECU according to the embodiment;

FIG. 21 is a diagram illustrating an example of the automatic parking by the parking assistance ECU according to the embodiment;

FIG. 22 is a diagram illustrating an example of the automatic parking by the parking assistance ECU according to the embodiment;

FIG. 23 is a diagram illustrating an example of the automatic parking by the parking assistance ECU according to the embodiment;

FIG. 24 is a diagram illustrating an example of the automatic parking by the parking assistance ECU according to the embodiment;

FIG. 25 is a diagram illustrating an example of the automatic parking by the parking assistance ECU according to the embodiment;

FIG. 26 is a diagram illustrating an example of the automatic parking by the parking assistance ECU according to the embodiment; and

FIG. 27 is a diagram illustrating an example of the automatic parking by the parking assistance ECU according to the embodiment.

### DETAILED DESCRIPTION

Hereinafter, embodiments of the present disclosure will be described with reference to the drawings. It is noted that each of the embodiments described below illustrates a specific example of the present disclosure. Therefore, respective components, the arrangement positions and connection modes of the respective components, respective steps, the order of the respective steps, and the like shown in the following embodiments are merely examples thereof, and are not intended to limit the present disclosure. Further, among the components in the following embodiments, components not described in the independent claims are described as any components.

Further, each of the drawings is a schematic view, and is not necessarily strictly illustrated. It is noted that, in each drawing, substantially the same configurations are denoted by the same reference numerals, and redundant description thereof will be omitted or simplified.

A parking assistance device according to the present embodiment described below suspends traveling of automatic parking when an interfering obstacle is detected during the automatic parking, and a notification means makes a notification regarding suspension of traveling of the automatic parking. This notification is intended to assist clearing the interfering obstacle, thereby making it possible to cancel suspension of the traveling of automatic parking at an early stage. In addition, a method of the present application determines a scene in which the vehicle stops at the time of automatic parking, and suppresses assistance when the vehicle is not in a scene in which it is required for an occupant to get off the vehicle so as to clears an obstacle, thereby preventing the occupant from being bothered unnecessarily.

In addition, conventionally, known is a technique of interrupting automatic parking after traveling of automatic parking is started, but a scene to which the parking assistance device according to the present embodiment is applied is not limited to a case in which automatic parking is interrupted after traveling of automatic parking is started. That is, the parking assistance device according to the present embodiment is also applicable to a case in which traveling of automatic parking is not started.

For example, after temporarily stopping a vehicle in front of an available parking space and activating an automatic parking function of the parking assistance device, the occupant may notice an interfering obstacle and may start a motion of getting off the vehicle. At such a time, the parking assistance device according to the present embodiment starts a notification useful for clearing an interfering obstacle. That is, the parking assistance device according to the present embodiment also functions even when the traveling of automatic parking is not started. The same applies to a case in which the start of traveling of automatic parking is suspended due to detection of an interfering obstacle.

In addition, the parking assistance device according to the present embodiment also functions in a case where the automatic parking is suspended by the operation of an automatic brake after the start of traveling of automatic parking, similarly to the conventional technique. For example, a three-dimensional object having a thin member such as an aluminum shopping cart may not be detected as an obstacle at a start position of automatic parking, or may erroneously recognize the position thereof. Therefore, the automatic brake may be operated after the start of traveling of automatic parking, or the occupant may first notice the state and may apply a brake, but the parking assistance device according to the present embodiment functions similarly in both cases. That is, the parking assistance device according to the present invention functions regardless of an anteroposterior relationship or a causal relationship between detection of an interfering obstacle and suspension of traveling of automatic parking.

In the present specification, not starting traveling of automatic parking and interrupting traveling of automatic parking are referred to as suspension of traveling of automatic parking, and are not distinguished from each other. On the other hand, in this specification, automatic parking and traveling of automatic parking are distinguished from each other as necessary.

The reason for this is that the automatic parking is processing in which the parking assistance device sets a parking route and causes a vehicle to travel along the parking route, and thus the automatic parking is started before traveling of automatic parking is started. That is, although the traveling of automatic parking looks like automatic parking itself in appearance, the traveling of automatic parking is different from the automatic parking. However, since it appears to the occupant that the traveling of automatic parking is the automatic parking itself, the traveling of automatic parking may be simply referred to as the automatic parking for convenience of description.

As an embodiment of the present application, an example of parking by learning type automatic parking and an example of parking a vehicle in a parking space detected by parking space detection are illustrated, but the application range of the present application is not limited to a specific parking method. For example, the present invention is also applicable to a case in which an occupant visually finds an obstacle when a space available for parking is detected on the basis of detection of sonar.

The present embodiment is particularly effective when parking is performed by learning type automatic parking. The learning type automatic parking is a method suitable for a case in which parking is repeatedly performed at the same position such as a garage at home. In the learning type automatic parking, learning traveling of manually parking a vehicle in a garage is performed in advance, a parking route and a parking position are stored at that time, and automatic traveling is performed along the stored route when automatic parking is performed. Therefore, since automatic traveling can be started from a position far away from the garage, there is a case in which an interfering obstacle is encountered while traveling.

In addition, even in a system in which a driver searches for an available parking space and activates a parking assistance device after stopping the vehicle in front of the available parking space, if the device has a function of the present application, an occupant can receive useful assistance only by activating the parking assistance device when clearing an obstacle in the available parking space.

Since the parking assistance device of the present embodiment has an advantage in responding to an interfering obstacle, a method of automatic parking is not specified. The present embodiment will be described on the assumption that the parking assistance device is activated and a parking route is set. A previous route calculation method, a subsequent automatic traveling method, and the like may be arbitrarily selected and performed, and thus a detailed description thereof will be omitted.

### Configuration of Vehicle

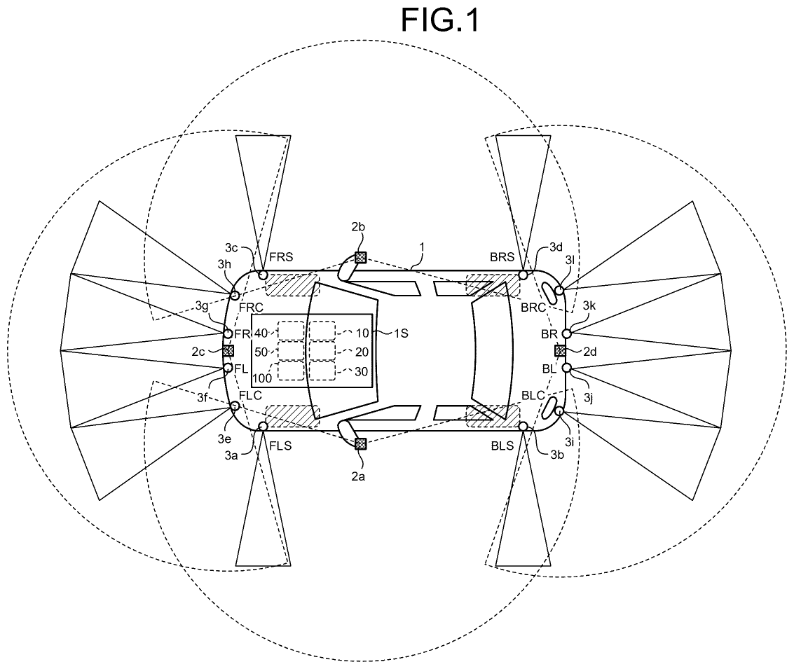

First, a vehicle to which the parking assistance device according to the embodiment is applicable will be described. FIG. 1 is a diagram illustrating a vehicle 1 to which the parking assistance device according to the embodiment is applicable. As illustrated in FIG. 1, the vehicle 1 is equipped with a parking assistance system 1S. The parking assistance system 1S includes an operation device 10, a human machine interface (HMI) device 20, a vehicle control device 30, a navigation device 40, a sonar ECU 50, and a parking assistance ECU 100. The parking assistance ECU 100 is an example of a parking assistance device.

It is noted that another device may be further mounted on the vehicle 1. Although the operation device 10, the HMI device 20, the vehicle control device 30, the navigation device 40, the sonar ECU 50, and the parking assistance ECU 100 are illustrated as separate devices in FIG. 1, some or all of these devices may be formed to be integrated with each other.

The operation device 10, the HMI device 20, the vehicle control device 30, the navigation device 40, the sonar ECU 50, and the parking assistance ECU 100 will be described later.

Cameras 2a, 2b, 2c, and 2d are respectively provided at four positions on the front, rear, left, and right sides of a vehicle body of the vehicle 1. Hereinafter, in a case where the cameras 2a, 2b, 2c, and 2d are not particularly distinguished from each other, the cameras 2a, 2b, 2c, and 2d are also simply referred to as a camera 2. Each of the cameras 2 includes a fisheye lens, and has a visual field range of 180 degrees or more in the horizontal direction.

Since each of the cameras 2 is attached with a depression angle in order to capture the road surface, when a range in which the road surface appears is converted into a horizontal visual field, a road surface (refer to a broken line) in a range of about 240 degrees appears in one camera 2. For example, a front wheel, a rear wheel, and the side surface of the vehicle body of the vehicle 1 are reflected in the captured images of the side cameras 2a and 2b respectively provided on the left and right sides of the vehicle body of the vehicle 1.

It is noted that the installation location and the number of cameras 2 are not limited to the example illustrated in FIG. 1.

As illustrated in FIG. 1, 12 sonar sensors 3a to 3l are installed in the vehicle 1. Hereinafter, in a case where the sonar sensors 3a to 3l are not individually distinguished from each other, the sonar sensors 3a to 3l are also simply referred to as a sonar sensor 3. When the sonar sensors are referred to individually, they are referred to in association with the installation positions thereof. For example, on the left side of the vehicle 1, the sonar sensor 3a is installed on the front side (FLS: Front Left Side) of the vehicle 1, and the sonar sensor 3b is installed on the rear side (BLS: Back Left Side) of the vehicle 1.

On the right side of the vehicle 1, the sonar sensor 3c is installed on the front side (FRS: Front Right Side) of the vehicle 1, and the sonar sensor 3d is installed on the rear side (BRS: Back Right Side) of the vehicle 1. These four sonar sensors are also referred to as side sonars because they respectively detect obstacles on the side portions of the vehicle.

On the front side of the vehicle 1, the sonar sensor 3e (FLC: Front Left Corner), the sonar sensor 3f (FL: Front Left), the sonar sensor 3g (FR: Front Right), and the sonar sensor 3h (FRC: Front Right Corner) are installed in this order from the left side in the forward direction of the vehicle 1.

The sonar sensor 3f and the sonar sensor 3g provided inside the vehicle detect an obstacle in the traveling direction when the vehicle 1 travels in the forward direction. In addition, the sonar sensor 3e and the sonar sensor 3h provided outside the vehicle detect an obstacle in a turning direction when the vehicle 1 turns. The sonar sensors 3e and 3h are also referred to as corner sonars. It is noted that, although the detection ranges of the four sonar sensors 3e, 3f, 3g, and 3h are indicated by triangles in FIG. 1, each of the detection ranges is not limited to the triangular range, and it is possible to detect an obstacle located about 10 m away from the vehicle. Detection ranges of the adjacent sonars are installed so as to overlap each other.

In addition, on the rear side of the vehicle 1, the sonar sensor 3l (BLC: Back Left Corner), the sonar sensor 3j (BL: Back Left), the sonar sensor 3k (BR: Back Right), and the sonar sensor 3l (BRC: Back Right Corner) are installed in this order from the left side in the forward direction of the vehicle 1.

The sonar sensor 3j and the sonar sensor 3k provided inside the vehicle detect an obstacle in the traveling direction when the vehicle 1 moves rearwards. In addition, the sonar sensor 3l and the sonar sensor 3l provided outside the vehicle detect an obstacle in the turning direction when the vehicle 1 moves rearwards and turns. The sonar sensors 3i and 3l are also referred to as a corner sonar. In FIG. 1, the directions detected by the four sonar sensors 3i, 3j, 3k, and 3l and the fan-shaped spread thereof are illustrated by triangles, but the detection range is not limited to the inside of the triangle in the drawing and is spread. For example, the adjacent sonars are installed such that detection ranges thereof overlap each other. The same applies to the four sonar sensors 3e, 3f, 3g, and 3h installed on the front side of the vehicle.

It is noted that the detection ranges of the sonar sensors 3a, 3b, 3c, and 3d installed on the side portions of the vehicle 1 are set to be narrower than the detection ranges of the sonar sensors installed on the front and rear sides of the vehicle 1. This is to improve the resolution of the position when the parking assistance ECU 100 detects the parking space on the side portion of the vehicle 1 by reducing the overlapping of the detection ranges of the side sonars when the vehicle 1 moves as much as possible.

In addition, each sonar sensor is installed at a height and a depression angle at which it is easy to detect surrounding obstacles when the vehicle 1 is parked. It is noted that the installation location and the number of the sonar sensors 3a to 3l are not limited to the example illustrated in FIG. 1.

Here, in the present embodiment, the sonar refers to a sonar system including the above-described sonar sensors 3a to 3l and the sonar ECU 50. The sonar ECU 50 is a control device that integrally controls the sonar system.

The sonar sensor 3 emits a directional sound wave and receives a reflected wave. The sonar ECU 50 detects a distance to an obstacle based on the time from when the sonar sensor 3 emits the sound wave to when the sonar sensor 3 receives the reflected wave. The sonar ECU 50 performs detection around a vehicle with a large number of sonars, and identifies the position of the obstacle based on detected distances from the plurality of sonar sensors 3.

In the sonar system, an obstacle in the traveling direction of the vehicle 1 is detected by the sonar sensor 3 provided in the bumper of the vehicle 1. Upon detecting the obstacle, the sonar ECU 50 determines whether the vehicle 1 collides with the obstacle. Upon determining that the vehicle 1 and the obstacle collide with each other within a predetermined time, the sonar ECU 50 instructs the vehicle control device 30 to operate an automatic braking function.

As a result, it is ensured that the vehicle 1 does not collide with front and rear obstacles even during automatic parking. In addition, by detecting an obstacle using the side sonars respectively provided on the left and right side surfaces of the vehicle body of the vehicle 1, it is also possible to predict that the side surface of the vehicle body approaches the obstacle due to the inner wheel difference.

It is noted that the sonar is not an essential component of the parking assistance system 1S. That is, the vehicle 1 may be configured not to include the sonar. In this case, for example, the parking assistance ECU 100 may detect a distance to the obstacle by processing a camera image captured by the camera 2. For example, the parking assistance ECU 100 may calculate the time until the vehicle 1 collides with the obstacle by processing the camera image. As a result, when the vehicle collides with an obstacle within a predetermined time, the parking assistance ECU 100 may instruct the vehicle control device 30 to operate an automatic braking function.

### Hardware Configuration of Parking Assistance ECU

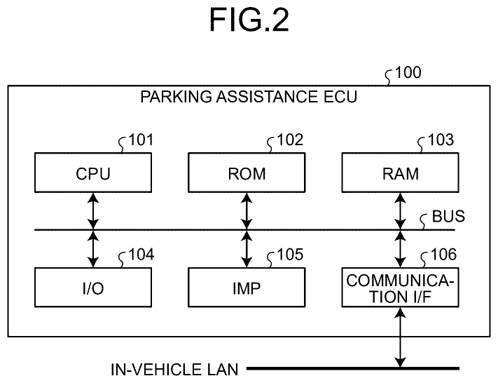

Next, a hardware configuration of the parking assistance ECU 100 will be described. The parking assistance ECU 100 is an example of a parking assistance device. FIG. 2 is a diagram illustrating an example of a hardware configuration of the parking assistance ECU 100 according to the embodiment. The function of the parking assistance ECU 100 to be described later may be implemented in hardware illustrated in FIG. 2.

The parking assistance ECU 100 may be a computer including a CPU 101, a ROM 102, a RAM 103, an input/output interface (I/O) 104, an image processor (IMP) 105, and a communication interface (I/F) 106, and connecting the respective elements to each other via a bus.

The parking assistance ECU 100 may house a plurality of elements in one chip. In addition, the parking assistance ECU 100 may include a plurality of chips as one element. The bus is not a single bus, and a plurality of types of buses may be combined.

For example, the CPU 101, the ROM 102, the RAM 103, the IMP 105, and the communication I/F 106 may be housed in one chip and connected to each other by a parallel bus, and the I/O 104 may be configured with a plurality of chips and connected to a chip housing the CPU 101 and a serial bus.

The parking assistance ECU 100 executes automatic parking by obtaining information from another device (for example, the navigation device 40) or giving an instruction to another device (for example, the vehicle control device 30) via the communication I/F and an in-vehicle LAN.

The CPU 101 controls the entire parking assistance ECU 100. The function of each unit of the parking assistance ECU 100 may be implemented in the form of a program executed by the CPU 101. The ROM 102 and the RAM 103 correspond to a storage unit, and the ROM 102 corresponds to a nonvolatile area. The RAM 103 is used for temporary storage as a work area of the CPU 101. For example, a camera image such as a display image or a detection image, information of a target object or a feature point detected from the image, or the like is temporarily stored in the RAM 103.

The IMP 105 is a processor specialized in image processing and parallel processing to improve processing performance. Processing of a part of the functions (for example, an image processing unit 120, a space recognition unit 130, and the like) of the parking assistance ECU 100 to be described later may be executed by the IMP 105.

### Function of Parking Assistance ECU

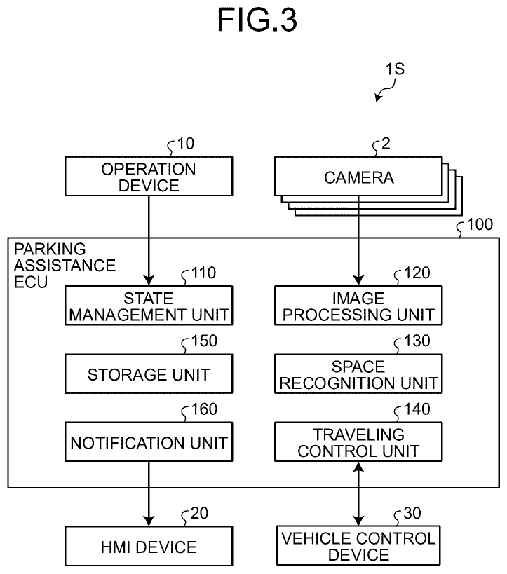

Next, functions of the parking assistance ECU 100 will be described. FIG. 3 is a block diagram illustrating a configuration example of a functional block of the parking assistance system 1S according to the embodiment. In FIG. 3, the function of the parking assistance ECU 100 is divided into a state management unit 110, an image processing unit 120, a space recognition unit 130, a traveling control unit 140, a storage unit 150, and a notification unit 160. As illustrated in FIG. 3, each of the cameras 2 (2c (F), 2d (B), 2a (L), and 2b (R)) outputs a captured camera image. The image processing unit 120 of the parking assistance ECU 100 receives the camera image and generates a display image or the like. The display image is output from the notification unit 160 to the HMI device 20.

The notification unit 160 superimposes a message on the display image or outputs a voice message in response to an instruction from the state management unit 110. The notification unit 160 is an example of a means of notification, and the HMI device 20, which is an output destination of the message, and the state management unit 110 that instructs the output of the message may also be included in the notification means. That is, the notification means is a functional element that transmits information to an occupant. Since the notification involves the state management unit 110, the notification unit 160, and the HMI device 20, they may be referred to as the HMI device 20 or the like.

The state management unit 110 receives a user's operation by the operation device 10 and controls a function of the parking assistance ECU 100 in response to the user's operation. Here, a touch panel of the navigation device 40 is included in the operation device 10.

The state management unit 110 receives position information from a main body (not illustrated) of the navigation device 40. The storage unit 150 stores a map including a route of automatic parking, and when the vehicle 1 stops near a start point of the route, the state management unit 110 collates the position information of a host vehicle indicated by the navigation device 40 with the position information of the start point described on the map, and starts automatic parking when the two pieces of position information substantially match each other. In addition, the state management unit 110 determines suspension of traveling according to the situation depending on the automatic parking. That is, the state management unit 110 is an example of an assistance control means that determines start or suspension of traveling of automatic parking.

The image processing unit 120 generates a display image and a detection image. The detection image is, for example, an image in which a change in luminance or color, that is, contrast is emphasized.

The space recognition unit 130 detects a target object or a feature point from the detection image and collates the position with the position of the target object or the feature point stored in the map, thereby estimating the self position. Since the proposed method may be arbitrarily selected as a method of self position estimation, a detailed description thereof will be omitted.

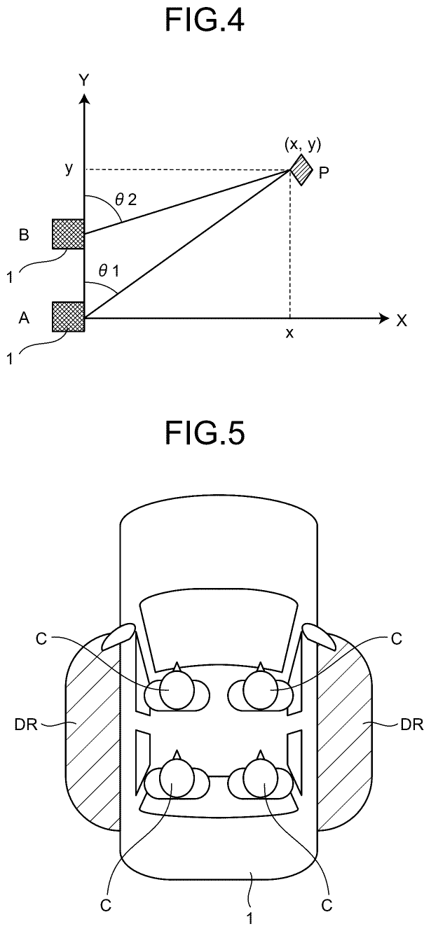

In addition, the space recognition unit 130 detects a position of an obstacle and a space in which there is no obstacle from the detection image. FIG. 4 is a diagram illustrating an example of processing in which the space recognition unit 130 specifies the position of an obstacle. As illustrated in FIG. 4, the space recognition unit 130 specifies the position of a target object (obstacle) P reflected in the camera 2 of the vehicle 1 by motion parallax. Specifically, first, the space recognition unit 130 converts the position of the target object P on the camera image into an angle (azimuth angle) of the target object P with respect to the vehicle 1. FIG. 4 illustrates a case in which the camera 2 of the vehicle 1 moves from a point A to a point B on the Y axis as the vehicle 1 moves. In this case, the image of the target object moves on the camera image, and the azimuth angle of the target object P reflected in the camera 2 changes from θ1 to θ2. Such a change in the azimuth angle (θ1→θ2) is referred to as motion parallax.

Since a distance between the point A and the point B (the length of a line segment AB) is a movement amount of the vehicle 1, it can be specified from the rotation speed of the wheel. The space recognition unit 130 can specify XY coordinates (x, y) of the target object P from the coordinates of the point A and the point B and the length of the line segment AB, θ1, and θ2 by the principle of triangulation. The position in the vertical direction in the image of the target object P reflected in the camera 2 corresponds to the height of the target object P. For example, when the target object P is a tip of a rod standing vertically on the ground, the target object P is reflected above the base of the rod in the screen. Therefore, if the space recognition unit 130 specifies the XY coordinates, the Z coordinate can be specified on the basis of the position in the vertical direction in the image. That is, the space recognition unit 130 can specify the three-dimensional coordinates of the target object P by applying the motion parallax appearing in the camera images captured at different time points to the principle of triangulation.

Furthermore, the space recognition unit 130 analyzes a distribution of motion parallax in the detection image. In the range where the road surface is shown in the detection image, the motion parallax gradually decreases as a distance from the vehicle increases, but the parallax discontinuously changes at a place where the three-dimensional object is shown. By using this, the space recognition unit 130 specifies a range in which there is no discontinuity in parallax from the analysis result of the distribution of the motion parallax, and can detect a range (free space) in which there is no three-dimensional object by causing the range to correspond to the range on the road surface.

Furthermore, the space recognition unit 130 receives detection information of an obstacle by sonar or the like, and reinforces recognition of the position of the obstacle and the space. For example, in the estimation of the position by the motion parallax, an error increases when the obstacle is in the traveling direction, and thus, the space recognition unit 130 may suppress the error in the position estimation by supplementing the distance information obtained by the sonar.

During automatic parking, the traveling control unit 140 controls the steering angle and the vehicle speed to cause the vehicle to travel along the route stored in the storage unit 150. Specifically, the traveling control unit 140 cooperates with the storage unit 150 and the space recognition unit 130 to set the steering angle and the vehicle speed. The space recognition unit 130 estimates the position of the host vehicle based on the position of the target object P reflected in the camera 2 at the time of automatic parking. The traveling control unit 140 calculates deviation from the route by collating the host vehicle position estimated by the space recognition unit 130 with the route stored in the storage unit 150.

In a case where the position of the vehicle 1 is off the route, the traveling control unit 140 controls a steering angle of the vehicle so as to change the steering angle in a direction in which the route of the vehicle 1 intersects the route, and changes the steering angle in a tangential direction of the route when the vehicle 1 overlaps the route. That is, the traveling control unit 140 feedback-controls the steering angle such that the position estimated by the space recognition unit 130 follows the route stored in the storage unit 150.

Since the vehicle 1 is more likely to deviate from the route as the vehicle speed and the steering angle of the vehicle 1 are larger, for example, the traveling control unit 140 may maintain the vehicle speed at 5 km/h or may decelerate the vehicle speed according to the steering angle during automatic parking. The traveling control unit 140 decelerates the vehicle speed of the vehicle 1 when the vehicle approaches an end point of the route, and when the vehicle 1 is stopped at the end point of the route, automatic parking of the vehicle 1 is completed at that time. Vehicle control of automatic parking is not a feature of the present application, and thus further description will be omitted.

The parking assistance device is not limited to the configuration exemplified as the parking assistance ECU 100 described above, and may have any configuration. The configuration example of the parking assistance ECU 100 disclosed in FIG. 3 corresponds to learning type automatic parking. In the learning type, since a traveling route at the time of learning travel is stored in the storage unit 150 as a parking route, a route calculation unit is not provided. In the case of a parking assistance device that performs parking assistance in a parking space detection type that detects a parking space from a camera image and calculates a parking route from a host vehicle to the parking space without performing learning travel, a parking space detection unit may be provided instead of the space recognition unit 130, and a route calculation unit that calculates a parking route may be further provided.

In the assistance regarding an interfering obstacle, which is an advantage of the present disclosure, the space recognition unit 130 detects an obstacle, the state management unit 110 makes a determination, and the notification unit 160 makes a notification to an occupant in many cases. However, some of these functions may be implemented by another device such as the navigation device 40. Further, another device may be included in the parking assistance device. In addition, the functional blocks may be arbitrarily referred to by different names.

### Range of Interfering Obstacle

The parking assistance ECU 100 according to the present embodiment suspends traveling of automatic parking and provides notification regarding the suspension when there is an interfering obstacle. The interfering obstacle is, among the obstacles present around the vehicle 1, an obstacle present in a range that obstructs vehicle parking or an obstacle present in a range that obstructs an occupant from getting off the vehicle when the vehicle is parked. Hereinafter, a range that obstructs a vehicle from parking or an occupant from getting off the vehicle when an obstacle is present will be referred to as an obstruction range. In other words, the interfering obstacle is an obstacle present in the obstruction range.

A range in which a distance to the vehicle 1 is equal to or less than a margin threshold value (also referred to as a clearance threshold value) when the vehicle 1 travels on the parking route is a range that obstructs vehicle parking (when an obstacle is present). The range is referred to as a parking obstruction range. The parking obstruction range is an example of the obstruction range. The margin threshold value is, for example, 15 cm.

A range in which a distance from the door is equal to or less than a getting-off room threshold value when the vehicle 1 is at the parking position is a range that obstructs an occupant from getting off the vehicle (when an obstacle is present). The range is referred to as a getting-off obstruction range. The getting-off obstruction range is an example of the obstruction range. The getting-off room threshold value is, for example, 30 cm.

An obstacle in the parking obstruction range and an obstacle in the getting-off obstruction range are interfering obstacles. However, the state management unit 110 does not set the getting-off obstruction range around a door through which an occupant does not get off the vehicle. For example, when the occupant gets off the driver's seat and automatic parking is resumed remotely (that is, in a case where a smart key that instructs automatic parking remotely is outside the vehicle), the state management unit 110 does not set the getting-off obstruction range for the door of the driver's seat. In this case, even if there is an obstacle at a position where the distance from the door of the driver's seat becomes 20 cm when the vehicle 1 is parked, the state management unit 110 may determine that there is no interfering obstacle and may start automatic parking. That is, since it is sufficient that automatic parking can be resumed, the state management unit 110 may perform assistance in clearing an interfering obstacle that obstructs the occupant from getting off the vehicle, or may cause the occupant to get off the vehicle in advance such that the obstacle does not interfere.

### Parking Obstruction Range and Getting-Off Obstruction Range

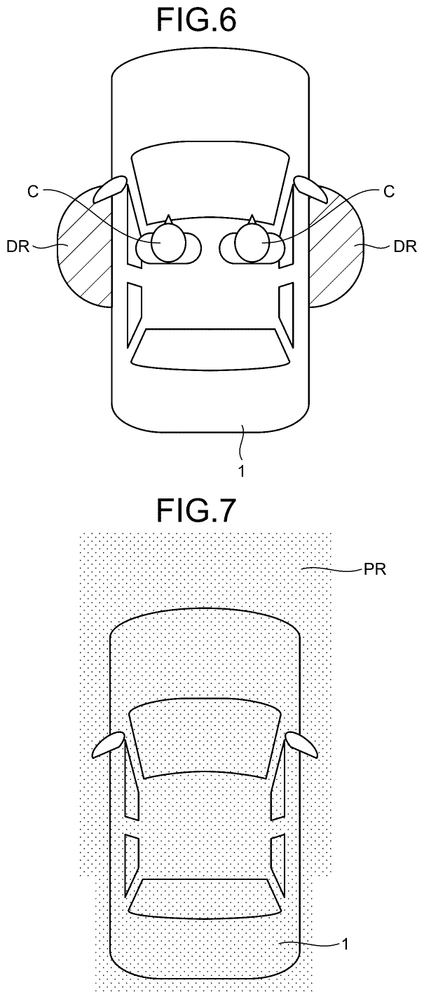

FIGS. 5 to 8 are diagrams illustrating examples of the getting-off obstruction range and the parking obstruction range, and FIGS. 5 and 6 illustrate the getting-off obstruction range. It is assumed that all the vehicles 1 in the drawing are located at the parking position. As illustrated in FIG. 5, when occupants C are seated on all the seats, the state management unit 110 sets a getting-off obstruction range DR around the doors of all the seats. The state management unit 110 does not set the getting-off obstruction range DR for the door of a seat where the occupant C is not present, as illustrated in the rear seat of FIG. 6.

The vehicle 1 detects a state of a seat belt and a state of a door by a known technique, and shares detection information with various devices by an in-vehicle LAN. The state management unit 110 of the parking assistance ECU 100 determines that the occupant C is present when the seat belt is fastened, and predicts that the occupant gets off the vehicle when the door is opened. For example, when the seat belt is removed and the door is not vacant, the notification unit 160 may blink the getting-off obstruction range DR corresponding to the seat from which the seat belt is removed under the control of the state management unit 110 so as to indicate that the getting-off obstruction range DR changes when the occupant gets off the vehicle.

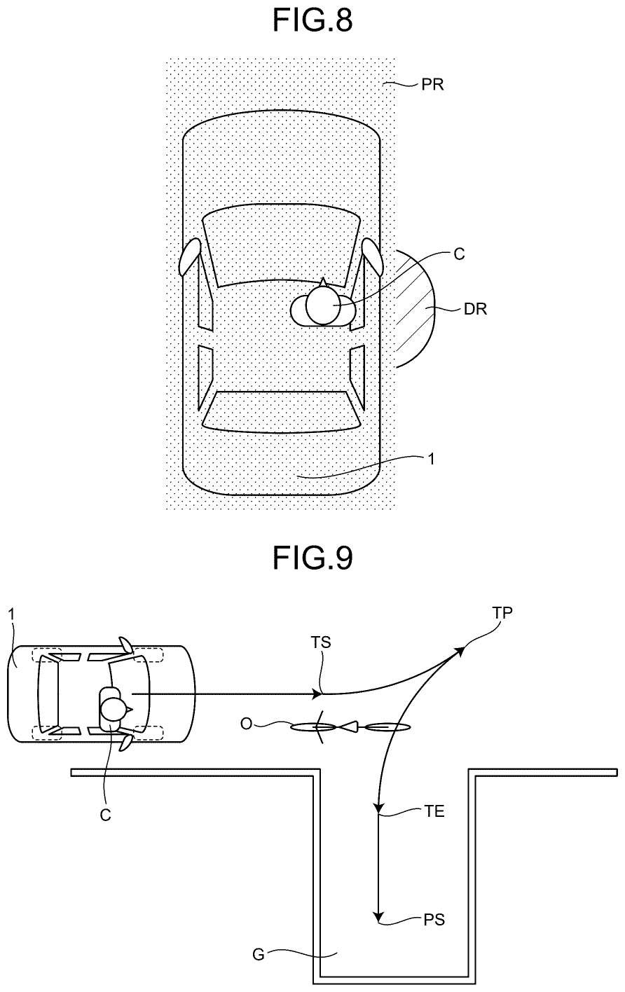

FIG. 7 illustrates a part of the parking obstruction range PR when the vehicle 1 travels rearwards in the straight direction to the parking position. Since the parking obstruction range PR is a range in which the distance to the vehicle 1 becomes equal to or less than the margin threshold value while the vehicle 1 moves from the parking start position to the parking position, the range illustrated in FIG. 7 is a small part of the parking obstruction range PR. FIG. 7 illustrates the vehicle 1 when the vehicle 1 is parked. Since the parking obstruction range PR is determined by a distance from the vehicle body of the vehicle 1, the parking obstruction range PR is determined with reference to a lateral width of the side mirror portion for the front side of the vicinity of the side mirror, whereas the width of the body of the vehicle body is used as reference for the rear side of the vicinity of the side mirror. When rearward parking is performed with the side mirror closed, as illustrated in FIG. 8, the lateral width of the parking obstruction range PR becomes narrowed in a range before the vicinity of the side mirror.

In a case where there is no occupant C in the vehicle, as illustrated in FIG. 7, only the parking obstruction range PR is an obstruction range. In a case where the occupant C is present in the vehicle, as illustrated in FIG. 8, the obstruction range is a range obtained by combining the parking obstruction range PR and the getting-off obstruction range DR. A range, which is the getting-off obstruction range DR and is not the parking obstruction range PR as in the area DR in FIG. 8, may be referred to as a getting-off obstruction range in a narrow sense.

### Notification Corresponding to Seating of Occupant

The state management unit 110 sets the getting-off obstruction range DR that obstructs the occupant C from getting off the vehicle when an obstacle is present corresponding to a seat on which the occupant C is seated. When the state management unit 110 determines that an obstacle detected by the space recognition unit 130 is present in the getting-off obstruction range DR, the notification unit 160 makes a notification about getting-off the vehicle of the occupant C based on the determination of the state management unit 110.

For example, the state management unit 110 sets, as the getting-off obstruction range DR, a range within 30 cm from the door of a passenger seat when the vehicle 1 is parked as a range where the occupant C of the passenger seat interferes when getting off the vehicle. When the state management unit 110 determines that the detected obstacle is not present in the parking obstruction range PR but is present in the getting-off obstruction range DR, the notification unit 160 notifies, for example, that “there is an obstacle at a position where interference is caused when an occupant gets off from the passenger seat”. In response thereto, when the occupant C of the passenger seat gets off the vehicle, the state management unit 110 may cause the notification unit 160 to make a notification indicating that “there is no obstacle that obstructs vehicle parking. Automatic parking can be resumed”.

In addition, the state management unit 110 may change a range in which movement of an obstacle is required so as to enable the occupant C to get off the vehicle. For example, when the buckle of the seat belt of the passenger seat is released while the parking obstruction range PR and the getting-off obstruction range DR are displayed, the notification unit 160 may blink the getting-off obstruction range corresponding to the passenger seat by alternately changing transmittance between 80% and 20%, and may recognize that the getting-off obstruction range DR changes when the occupant of the passenger seat gets off the vehicle.

In addition, the notification unit 160 may make a notification in response to movement of the obstacle. For example, when the obstacle is moved and placed in the getting-off obstruction range DR corresponding to the driver's seat, the notification unit 160 makes a notification indicating that “there is an obstacle at a position where interference is caused when an occupant gets off from the driver's seat”. In response thereto, when the buckle of the seat belt of the driver's seat is released, the notification unit 160 may make a notification indicating that “automatic parking can be resumed from the outside of vehicle using a smart key” so as to prompt the occupant to perform a remote parking operation.

Environmental Dependency with Room and Margin

Next, the room and margin (safety margin) will be described. The state management unit 110 sets a margin threshold value to, for example, 15 cm and a getting-off room threshold value to, for example, 30 cm, but may add or subtract the room or margin depending on the situation. In addition, the state management unit 110 may change a starting point of the margin according to the state of the vehicle 1.

Since the starting point of the margin is a portion that passes through the outermost side of the vehicle body of the vehicle 1, the tip of the side mirror becomes the starting point of the margin with respect to the side of the vehicle body at the time of traveling straight. In a case where closing the side mirror is determined as the control of the vehicle 1 when the vehicle travels rearwards in the straight direction in the final section of automatic parking, the state management unit 110 may set the starting point of the margin on the side of the vehicle body to the side surface of the vehicle body instead of the tip of the side mirror, or may set the maximum protruding position of the closed side mirror. Further, for example, the state management unit 110 may set the margin threshold value to 10 cm only in the last section in which the side mirror is closed and the vehicle travels rearwards in the straight direction. Accordingly, in the case of a narrow garage, it is possible to prevent the occupant C from being bothered by unnecessary assistance.

In addition, when the road surface is frozen, the wheels of the vehicle 1 may slip and deviate from the parking route. Therefore, for example, in a case where the temperature is 5 degrees or less and the time is early morning, the state management unit 110 may set the margin threshold value to 30 cm. In this way, when the obstacle is kept farther away from the vehicle than the normal time, a possibility that the vehicle comes into contact with the obstacle decreases even if the wheels of the vehicle skids on the frozen road surface.

Further, when the inclination of the road surface is large or when the wind is strong, the state management unit 110 may increase the getting-off room threshold value. Both the obliquity and the strong wind can be detected by an acceleration sensor. In this way, if the obstacle is kept away from the periphery of the door, the possibility that the vehicle comes into contact with the obstacle decreases even if the door is inclined or widely opened by wind.

Assistance in Clearing Obstacle and Moving it at Position where Interference is not Caused

When there is an interfering obstacle, under the control of the state management unit 110, the notification unit 160 makes any one of a notification as to a range (obstruction range) where an obstacle interferes when being present, a notification indicating an interfering obstacle, a notification indicating a position at which an interfering obstacle is to be cleared, a notification indicating a movement distance until an interfering obstacle becomes no longer an obstacle, and a notification reporting that an obstacle no longer interferes.

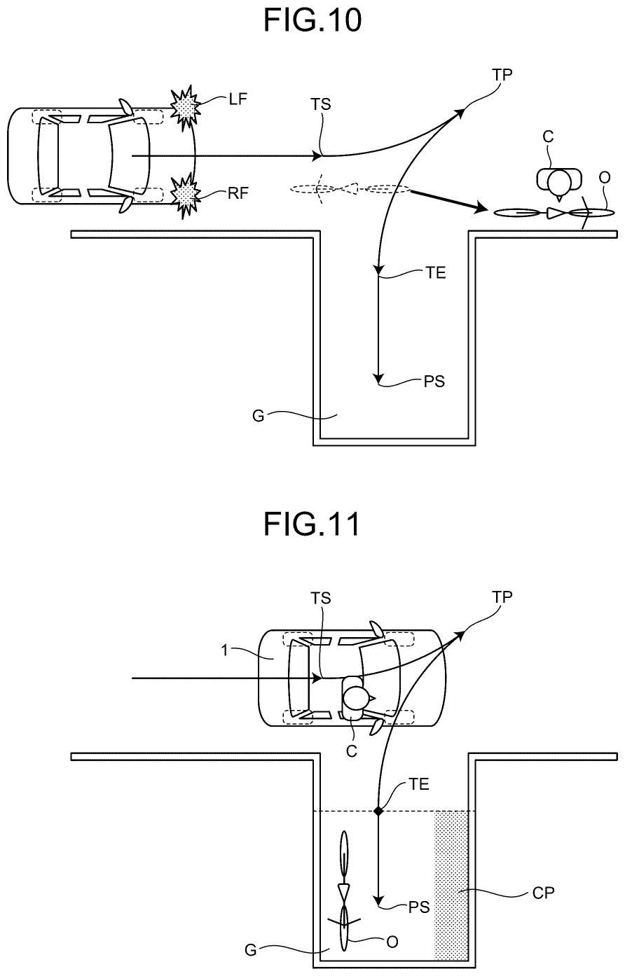

Here, FIGS. 9 and 10 are diagrams each illustrating an example of assistance in clearing an obstacle to a position where interference is not caused. When the parking route of the vehicle 1 is illustrated, a midpoint of the rear wheel axle of the vehicle 1 is illustrated as a representative point representing the position of the vehicle 1, and a route through which the representative point passes in the process of parking is illustrated as a parking route. As illustrated in FIG. 9, it is assumed that the vehicle 1 moves straight up to a turning start position TS and then starts turning there, performs steering wheel turn-back at a turn back position TP, ends turning of the vehicle at a turning end position TE, and performs automatic parking for vehicle parking at a parking position PS in a garage G. In a case where the space recognition unit 130 detects a left bicycle as an obstacle O while the vehicle 1 travels straight toward the turning start position TS, the notification unit 160 makes a notification, for example, indicating that “move an obstacle located on the front-and-right side 4 m away from the vehicle in the forward direction”.

In addition, although not illustrated, the notification unit 160 may illustrate a range within 1.2 m on the left and right of the parking route (a range corresponding to the parking obstruction range PR) in a bird's-eye view and may display the range as a range (obstruction range) where the obstacle O interferes when bing present. In addition, as illustrated in FIG. 10, the notification unit 160 makes a notification by light emission of a left headlight LF and a right headlight RF of the vehicle 1 when the vehicle is moved out of the range where the obstacle O interferes. Alternatively, the notification is notified to the occupant by voice indicating that “the vehicle is moved out of the range where interference is caused”. Then, it is possible to prevent the occupant C from moving the obstacle O away from the vehicle more than necessary and wastefully consuming time.

Notification as to Range where Interference is not Caused

Next, a notification as to a range where interference is not caused will be described. FIGS. 11 and 12 are diagrams each illustrating an example of a notification as to a range where interference is not caused. As illustrated in FIG. 11, when the obstacle O in the garage G is detected, the notification unit 160 makes a notification indicating a position CP at which the obstacle O is to be cleared. The state management unit 110 sets the position CP at which the obstacle O is to be cleared based on a parking route (→TS→TP→TE→PS) and the size of the obstacle O.

As illustrated in FIG. 11, when the obstacle O is a two-wheeled vehicle, the state management unit 110 may estimate that the obstacle O falls within an occupied area CP, for example, having a width of 80 cm and a length of 2 m. Alternatively, as illustrated in FIG. 12, the position at which the two-wheeled vehicle is to be cleared may be estimated in accordance with the shape of the two-wheeled vehicle. In the garage G, the state management unit 110 determines whether the occupied area CP and the position at which the two-wheeled vehicle is to be cleared in accordance with the shape of the two-wheeled vehicle fall within a range where interference is not caused. When the occupied area CP and the position at which the two-wheeled vehicle is to be cleared fall within the range, the state management unit causes the notification unit 160 to make a notification as to the occupied area CP and the position at which the two-wheeled vehicle is to be cleared in accordance with the shape of the two-wheeled vehicle.

The range where interference is not caused is a range that is not included in the parking obstruction range PR and the getting-off obstruction range DR. The state management unit 110 sets the getting-off obstruction range DR based on the seat on which the occupant C sits. However, regarding the driver's seat, the getting-off obstruction range DR is not set in the driver's seat when the driver gets off the vehicle with a key, whereas the getting-off obstruction range DR is set in the driver's seat when the driver leaves the key in the vehicle and gets off the vehicle.

### Notification as to Whether or not Interference is Caused

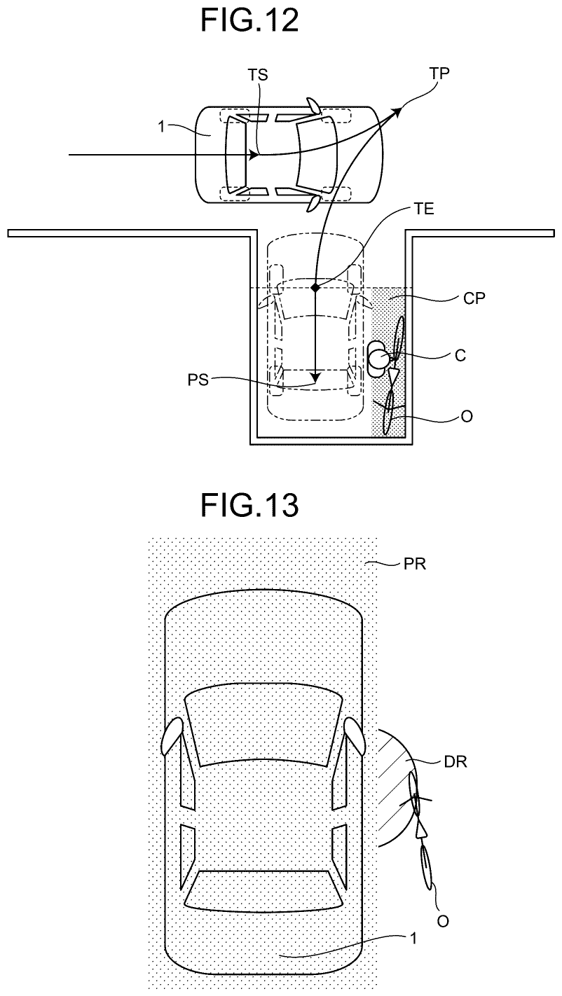

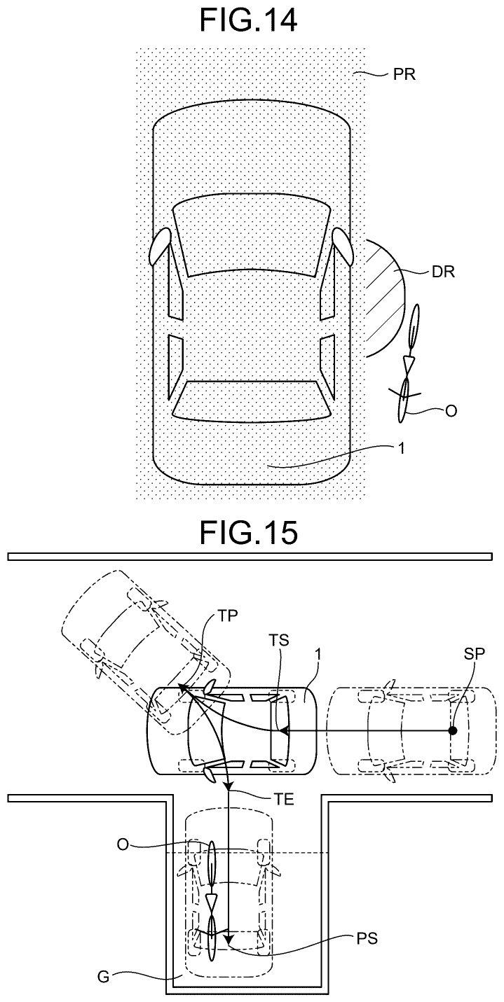

Next, a notification as to whether or not interference is caused will be described. FIGS. 13 and 14 are diagrams each illustrating an example of a notification as to whether or not interference is caused. For example, as illustrated in FIG. 13, when a wheel or a steering wheel of a two-wheeled vehicle enters the getting-off obstruction range DR, it is notified that the wheel or the steering wheel interferes. As illustrated in FIG. 14, when a vehicle body of the two-wheeled vehicle does not enter the getting-off obstruction range DR, it may be notified that the two-wheeled vehicle does not interfere with the getting-off obstruction range DR, or a notification indicating that the two-wheeled vehicle interferes with the getting-off obstruction range DR may not be made. In addition, when the two-wheeled vehicle is cleared away from the range where interference is caused, it may be notified that further movement of the two-wheeled vehicle is unnecessary.

The position of the obstacle may be estimated based on the position of the occupant. For example, in a case where the state management unit 110 does not detect an obstacle interfering when the occupant C gets off the vehicle, the state management unit 110 may cause the space recognition unit 130 to detect the occupant C from the camera image and specify the standing position of the occupant C. The reason for this is that, in a case where the obstacle O is a small object, the obstacle O may not be able to be detected behind the occupant C. At that time, the state management unit 110 may cause the space recognition unit 130 to detect the standing position of the occupant C, may determine whether or not interference is caused by regarding the position of the occupant C as the position of the obstacle O, and may cause the notification unit 160 to notify the result.

As described above, the notification unit 160 may make a notification when the obstacle O goes out of the range in which the obstacle O interferes, or may make a notification when there is an inquiry action of the occupant C. The inquiry action is, for example, an action such as turning the face toward the vehicle 1, stopping, or returning to the vehicle 1. When the space recognition unit 130 detects a face image based on the camera image and detects the face of the occupant C as a result, the state management unit 110 may determine that there is the inquiry action. Then, if the occupant C turns around the vehicle when the occupant C wants to know whether the movement of the obstacle has been sufficient, the vehicle 1 is notified whether the obstacle has been moved sufficiently.

When there is the inquiry action, the notification unit 160 notifies the presence or absence of the interfering obstacle O. The means of notification may be made by emitting a sound or controlling a light. For example, as illustrated in FIG. 13, the notification unit 160 may blink a vehicle width lamp once when the obstacle O interferes, and may blink the vehicle width lamp twice when the obstacle O does not interfere, as illustrated in FIG. 14. In this case, when the occupant C turns around the vehicle 1, the occupant C may continuously move the obstacle O away from the vehicle if the vehicle width lamp blinks once, and may drop the obstacle O if the vehicle width lamp blinks twice.

The notification unit 160 may make a notification in a different manner depending on a case in which the obstacle O is present in the parking obstruction range PR and a case in which the obstacle O is only present in the getting-off obstruction range DR. When the key is in the vehicle, the state management unit sets the getting-off obstruction range DR in the driver's seat. Therefore, when the obstacle O is only in the getting-off obstruction range DR in the driver's seat, the state management unit 110 may make a notification by voice indicating that automatic parking can be resumed remotely by holding the key.

### Assistance in Stopping Vehicle at Suitable Position for Clearing Obstacle

Although assistance in clearing an obstacle has been described so far, assistance before starting clearing the obstacle will be described using vehicle parking of FIG. 15 as an example. FIG. 15 is a diagram illustrating an example of assistance in stopping a vehicle at a suitable position at which an interfering obstacle is cleared. In the example of FIG. 15, the garage G faces the road, and the long side of the garage is perpendicular to the road. The road is wide enough for the car to make a mistake.

The parking assistance ECU 100 mounted on the vehicle 1 of FIG. 15 supports learning type automatic parking, and stores a parking route in advance. The parking route starts at a start position SP on the road, in which the start position is located right before the entrance of the garage G. The vehicle 1 starts automatic parking at the start position SP and travels straight on the left side of the road up to a turning start position TS. The vehicle 1 starts turning at the turning start position TS in front of the garage, and turns the vehicle 1 by 45 degrees up to a turn back position TP so as to temporarily stop. The vehicle 1 starts to move rearwards after stopping at the turn back position TP, and turns 45 degrees until the vehicle 1 reaches a turning end position TE so as to end turning of the vehicle. The vehicle 1 sets the steering angle to zero at the turning end position TE, moves rearwards in the straight direction toward the inside of the garage G, and is parked at the parking position PS. In the example of FIG. 15, the parking position is shifted to the left side of the garage so as to allow the driver to get on and off the vehicle in the garage G.

The navigation screen displayed on the HMI device 20 of the vehicle 1 displays the rear view when a gear is reversed at the turn back position TP. If there is a bicycle (obstacle O) in the garage G as illustrated in FIG. 15, there is a case in which the user notices the bicycle when passing through the front side of the garage. However, since a driver basically checks the safety by looking at the traveling direction while a vehicle is moved forwards, there is a case in which the driver notices an interfering obstacle for the first time when the driver stops the vehicle at the turn back position TP and checks the rear side of the vehicle.

In this case, the driver can stop automatic parking at the turn back position TP and get off the vehicle to clear the obstacle O. However, in a state in which the vehicle 1 blocks the road, the driver may feel a possibility that the vehicle 1 blocks the passage of other vehicles on the road while the driver gets off the vehicle and clears the obstacle, which causes the driver to feel uncomfortable and makes clearing the obstacle difficult. In addition, when the vehicle 1 is moved by manual driving to a position at which the passage of other vehicles is not hindered by the vehicle 1, the vehicle 1 deviates from the route, and thus automatic parking cannot be resumed.

Therefore, when there is the interfering obstacle O, the state management unit 110 may stop the vehicle 1 at a position not causing hinderance of the passage of other vehicles. Specifically, when the vehicle 1 is parallel to the road before the turning start position TS, the state management unit 110 may instruct the notification unit 160 to confirm the presence or absence of the interfering obstacle O with the occupant C or instruct the space recognition unit 130 to detect the interfering obstacle O. In the latter case, when the interfering obstacle O is detected, the traveling control unit 140 is instructed to stop the vehicle 1 before the turning start position TS. In this manner, when there is the interfering obstacle O, the vehicle stops manually or automatically before the start of turning. Therefore, even if other vehicles pass on the road while the occupant gets off the vehicle so as to clear the interfering obstacle O, the vehicle does not hinder the passage of the other vehicles. Therefore, the occupant can continuously clear the obstacle.

### Control to Decelerate/Stop Vehicle at Suitable Position for Clearing Obstacle

There is a case in which the vehicle 1 does not include a sonar sensor on the front side, and the space recognition unit 130 processes a portion of a front camera image in which the front is reflected so as to detect an obstacle, and emergency braking is performed according to the detection result. In this case, a range in which the obstacle is detected is limited to the road and, as such, the obstacle in the garage G is not detected. In addition, if the processing of the side camera image showing the inside of the garage G is interrupted to the processing of the front camera image, the obstacle detection for the front side of the vehicle may be delayed, which may cause the emergency braking not to be performed in time. Therefore, when the side camera reaches a position at which the inside of the garage G can be captured, the traveling control unit 140 may decelerate the vehicle speed so as to decrease the vehicle speed. In a case where the vehicle is decelerated in advance, even if the obstacle detection for the front side of the vehicle is delayed, the emergency braking is performed in time. Therefore, the state management unit 110 can cause the obstacle detection in the garage to be interrupted between the times of the obstacle detection for the front side of the vehicle.

In addition, the traveling control unit 140 may simultaneously decelerate the vehicle when urging the occupant to confirm the parking position (in the garage). Since the occupant notices the decelerating acceleration, the occupant easily notices that the notification has been made if the notification is simultaneously made with the deceleration. When the vehicle decelerates, a time margin for confirmation is increased, and the vehicle can stop in a short time when an obstacle is detected.

The state management unit 110 may instruct the traveling control unit 140 to temporarily slow down or stop the vehicle 1 so as to detect the inside of the garage G during that time. Since there is no need to detect an obstacle in front of the vehicle while the vehicle is stopped, the space recognition unit 130 may detect only an obstacle in the garage G. In addition, the state management unit 110 may instruct the traveling control unit 140 to decelerate the vehicle 1 at a position where the inside of the garage G can be visually recognized, and may cause the occupant C to confirm the inside of the garage G before causing the space recognition unit 130 to detect the inside of the garage G.

That is, the parking assistance ECU 100 causes, when the vehicle passes by the front side of the garage G, the occupant C to visually confirm the inside of the garage G without causing the space recognition unit 130 to detect the inside of the garage G. Here, when the occupant C depresses the brake to stop the vehicle 1, the parking assistance ECU 100 causes the space recognition unit 130 to detect the inside of the garage G. Alternatively, the space recognition unit 130 may detect the inside of the garage G when the occupant decelerates the vehicle in front of the garage G, and may stop the vehicle 1 when the obstacle O is detected as a result. That is, when the occupant is considered to have found an obstacle, the detection means detects the obstacle. Either an anteroposterior relationship or a causal relationship may be used, but both the detection by the detection means and the recognition by the occupant may be performed.

Currently, obstacle detection using a camera or a sonar sensor has a limit in performance. Here, the obstacle O determined to interfere in the detection is present at a position where the obstacle O does not interfere, or the obstacle O determined to be present at a position where the obstacle O does not interfere in the detection is present at a position where the obstacle O interferes. Therefore, when detecting the obstacle O near the parking obstruction range PR or the getting-off obstruction range DR, the state management unit 110 may make an inquiry to cause the occupant C to determine whether or not the obstacle O interferes.

Alternatively, when the occupant C stops the vehicle, detection may be performed by the detection means, and the result may be notified. There is no problem as long as the detection result and the recognition of the occupant coincide with each other, but when the detection result and the recognition of the occupant do not coincide with each other, the determination of the occupant C may be prioritized. For example, there is a case in which, when an occupant stops the vehicle 1, an undetected object such as a small tool may fall, or a case in which, when the automatic brake is activated, there is no obstacle and a step may be erroneously detected. Therefore, the occupant may receive a notification of a detection result by the detection means, may ignore the detection result if the occupant has confidence in cognition, and may get off the vehicle for confirmation of the detection result if the occupant does not have confidence.

### Necessity of Assistance Depending on Situation

On the other hand, even if the obstacle O is detected in a clearly disturbing position, there are many cases in which assistance in clearing the obstacle is not required. For example, in a case where a gate door of a garage has a structure that detects approach of the vehicle 1 and automatically opens the gate door, it is sufficient that the vehicle stops temporarily and wait for the gate door to open, and thus, the notification regarding the obstacle O is merely troublesome. When a pedestrian or another vehicle approaches the vehicle, it is sufficient that the vehicle waits until the detection of the obstacle O disappears, and thus it is not necessary for the occupant to get off the vehicle. Even when it is necessary to manually open the gate of the garage, it is troublesome to be notified of the same thing every time.

As described above, since the presence or absence of the necessity of assistance is not determined only by the interfering obstacle O, the occupant C may determine whether or not to perform assistance corresponding to the interfering obstacle O. Then, it is possible to avoid inconvenience the occupant C caused by performing assistance in an unnecessary case.

However, the fact that the determination is required may also be bothersome. Most of the cases where the vehicle stops in the middle of automatic parking do not require assistance in clearing the obstacle O, and are solved if the vehicle waits for a pedestrian or an approaching vehicle to leave. For this reason, while repeated determination is required, the operation becomes bothersome. Eventually, an assistance function is considered unnecessary, and the function may be set to OFF. Then, when the assistance is required, the assistance function may not work.

Therefore, the state management unit 110 preferably discriminates between a case in which the assistance is required and a case in which the assistance is not required as accurately as possible, and when it is determined that the assistance is not required, it is preferable not to provide the assistance or to provide restrained assistance so as not to trouble the occupant, and when it is determined that the assistance is required, it is preferable to provide the assistance in a positive manner. For example, the state management unit 110 also functions as a scene determination means that determines that a scene requires assistance.

Here, regarding the restrained assistance means, for example, the necessity of assistance is inquired by a notification that is merely displayed on a screen without voice or lighting or in a form that can be ignored. Here, a notification is made when Yes is provided in response to the inquiry, whereas nothing is done when the inquiry is ignored.

### Suppression of Assistance Based on History

Depending on the facility of a parking lot, the vehicle 1 may always stop temporarily. For example, in a case where there is a shutter that is opened and closed by a remote controller in the garage G, the occupant C temporarily stops the vehicle 1, operates the remote controller, waits for the shutter to be opened, and resumes automatic parking. Therefore, it is preferable that the storage unit 150 stores, as a parking history, a stop position of the vehicle for a certain period of time or more during automatic parking and a fact that the occupant C has not gotten off the vehicle. Then, when the behavior of the vehicle 1 and the occupant C substantially matches the parking history, the state management unit 110 may suppress or do not support the assistance.

Here, the suppression of assistance means that, for example, the notification unit 160 displays “do you want to receive a notification about an obstacle?” as a text on the screen and does not make an inquiry by voice. Then, the occupant C can receive the notification only when a Yes button is pressed. When the assistance is not required, the message may be ignored, and the voice is not emitted, thereby avoiding an annoying situation.

It is noted that, when the door of the garage G is opened by the remote controller, it may be found that there is an obstacle O in the garage G. Therefore, even in a case where it is determined that the assistance is not performed based on the history, the state management unit 110 may continuously perform the scene determination, and when there is a behavior different from the history or an obstacle is detected, the state management unit may actively make a notification as to the obstacle.

For example, in a case where the occupant does not get off the vehicle when the vehicle stops at the stored position, the parking history is followed, and only the restrained notification displayed on the screen is performed. However, when the occupant C performs a getting-off preparation motion that is not historically stored, such as turning on a hazard lamp or a blinker, or operating a buckle of a belt, the state management unit 110 may instruct the notification unit 160 to start an active notification by voice.

Here, the getting-off preparation motion is, for example, a motion leading to getting-off the vehicle, such as stopping with a brake pedal, operating a parking brake (PB), releasing the brake pedal, setting a gear to P (parking) or N (neutral), releasing a buckle of a seat belt, and opening a door. Even if the vehicle stops at a place which is the same as a place where the vehicle stopped but the occupant did not get off the vehicle in the history, the state management unit 110 may assume that a situation different from a normal situation occurs outside the vehicle when the getting-off preparation motion that is not stored in the history is detected, and may start a notification as to the obstacle O. It is noted that, when the vehicle stops at a place different from the place where the vehicle stopped but the occupant did not get off the vehicle in the history, and the parking brake is operated, a notification by voice may be started without waiting for further getting-off preparation motion.

### Suppression of Assistance Based on Detection

Furthermore, the state management unit 110 may determine the necessity of assistance based on the detection result. For example, the state management unit 110 may perform face detection or human detection on the image of the obstacle O and may determine that the assistance is unnecessary in a case where the interfering obstacle is a person. The reason for this is that, when the obstacle is a person, it can be expected that the person notices that a host vehicle is in the middle of parking and leaves the place. In addition, the state management unit 110 monitors the position of the obstacle O, and in a case where the position of the obstacle O is moving away from the vehicle, the obstacle O does not become an obstacle when time elapses, and thus, the state management unit 110 may determine that the assistance is unnecessary.

In addition, the state management unit 110 may determine, based on the history, a time point to be determined based on the detection. For example, even if the space recognition unit 130 performs detection when the shutter of the garage G is closed, the parking position PS cannot be detected. Therefore, for example, the state management unit 110 does not make a notification or perform assistance until a vehicle stoppage time recorded in the history elapses, and performs detection when the recorded vehicle stoppage time elapses so as to determine whether to make a notification or perform assistance. Therefore, when the space recognition unit 130 detects the obstacle O at the stop position of the vehicle, the detection of the obstacle O and the suggestion of the assistance may be notified by voice.

In addition, the state management unit 110 may make a determination by collating the detection result with the history. For example, in a mechanical parking lot or a parking lot having a turntable, the occupant C always gets off the vehicle and operates an operation panel. Even in such a parking lot, there is a case in which assistance is necessary and a case in which assistance is not necessary, and thus, it is preferable that the state management unit 110 collates the detection result with the history to make a determination.

For example, the state management unit 110 may track the position of the occupant C outside the vehicle and compare the movement direction of the occupant C with the history. In this case, the notification unit 160 may not make a notification when the occupant C moves in the direction recorded in the history (for example, toward the motion panel), and may start a notification by voice when the occupant C moves in a direction different from the history (for example, toward the turn back position TP). In addition, when the getting-off preparation operation (for example, turning on the hazard lamp) is detected after the vehicle stops at a position not recorded in the history, the state management unit 110 may start active assistance before the occupant C gets off the vehicle.

### Suppression of Assistance Based on Probability

The state management unit 110 may determine whether or not assistance is necessary on the condition that such a small number of events and combinations thereof are established. However, the state management unit may comprehensively evaluate a probability that assistance is necessary based on a large number of events, and may select whether the notification is made or not or may select a mode of the notification based on the probability. For example, if the probability is high, the notification may be made, and if the probability is low, the notification may not be made, or if the probability is high, an active notification may be made, and if the probability is low, a restrained notification may be made. Alternatively, by combining the two selections, an active notification may be made if the probability is high, no notification may be made if the probability is low, and a restrained notification may be made if the probability is intermediate between the both.

As the comprehensive evaluation, for example, the state management unit 110 sums the evaluation values of the probabilities and compares the summed-up evaluation value with a first threshold value and a second threshold value. Then, the state management unit 110 does not perform assistance when the summed-up evaluation value is less than the first threshold value, performs restrained assistance when the summed-up evaluation value is equal to or greater than the first threshold value and less than the second threshold value, and aggeressively performs assistance when the summed-up evaluation value is equal to or greater than the second threshold value.

In addition, the state management unit 110 may continue the evaluation of the probability even after the assistance is started, and may stop the assistance or switch to the restrained assistance when the evaluation value of the probability falls below the threshold value. For example, when the vehicle 1 stops at a position corresponding to the history, the state management unit 110 may make a determination so as to perform restrained assistance and may notify the occupant C of an obstacle in a direction of the parking position only by an image before the occupant C gets off the vehicle. Thereafter, the notification may be stopped when the occupant C stops at a position corresponding to the position in the history (for example, in front of an operation panel of a mechanical parking lot or the like), or the notification may be stopped when an obstacle (for example, a door of a garage) in the direction of the parking position PS is no longer detected.

Furthermore, the state management unit 110 may continue the evaluation of the probability even after the assistance is stopped, and may resume the assistance when the evaluation value of the probability exceeds the threshold value. For example, the state management unit 110 may make a determination so as to actively perform assistance when the occupant C does not return to the vehicle 1 after stopping the assistance when the occupant C stops in front of the operation panel and moves toward the direction of the parking position (in the garage), and may make a notification with a voice corresponding to the position of the obstacle O in the garage G.

### Exemplary Evaluation Criteria of Probability

Hereinafter, evaluation criteria of the probability will be exemplified. The state management unit 110 may start the evaluation of the probability when the obstacle O is detected, may start the evaluation of the probability when the occupant starts deceleration, or may start the evaluation of the probability when automatic parking is started. For example, the state management unit 110 highly evaluates the probability in a case where a time difference from when the occupant C is requested to confirm the parking position to when a brake operation is detected is short. The reason for this is that, if the time difference is short, it can be estimated that the occupant C has found the obstacle O when confirming the inside of the garage G.

When a time from stopping the vehicle to the getting-off preparation motion is short, the state management unit 110 highly evaluates the probability. The reason for this is that, if the time difference is short, it can be estimated that the occupant C is confident that clearing an obstacle is necessary.

The state management unit 110 adds the probability every time the getting-off preparation motion such as the operation of a brake pedal, the operation of a parking brake, the release of the brake pedal, setting a gear to P or N, the release of a buckle of a seat belt, or opening of the door is performed. The reason for this is that the assistance is not required unless the occupant gets off the vehicle, and when the probability that the occupant gets off the vehicle increases, the probability that the assistance is required also increases. Therefore, the closer the occupant gets off the vehicle, the higher the probability.

The state management unit 110 evaluates the probability lower in a case where there are many occupants C who perform the getting-off preparation operation, and particularly, in a case where all the occupants get off the vehicle than in a case where only one occupant gets off the vehicle. The reason for this is that it is reasonable to consider that, when a large number of people get off the vehicle, they have made a selection to get off the vehicle before parking the vehicle in a garage and remote parking has been performed.

The state management unit 110 highly evaluates a probability when a direction in which the obstacle O has been detected matches a seat at which the getting-off preparation motion has been performed. The reason for this is that it is reasonable to consider that the occupant C on the side close to the obstacle O gets off the vehicle and clears the obstacle O.

The space recognition unit 130 specifies the position of the obstacle O based on a camera image, and the state management unit 110 calculates a closest distance when the obstacle O comes closest to the vehicle body based on a positional relationship between a parking route and the obstacle O, and evaluates the probability higher as the closest distance is shorter. It is noted that, when the obstacle O hits the vehicle body, the state management unit 110 evaluates the closest distance as zero, and sets the evaluation value of the probability as an upper limit value.

Furthermore, the space recognition unit 130 may estimate a size of the obstacle O based on the camera image, and the state management unit 110 may evaluate the probability based on the size of the obstacle O. Specifically, the space recognition unit 130 evaluates a length and a width of the obstacle O, and the state management unit 110 evaluates the probability based on a larger one of the length and the width. For example, if the length is less than 1.5 meters, the probability is evaluated to be high, and if the length is 1.5 meters or more, the probability is evaluated to be low. The reason for this is that a small object such as a bicycle or a trash can is cleared when an occupant moves the small object, whereas a large object such as a gate door of a garage does not require assistance because a moving method for the large object is determined in many cases. In addition, even in a case where the obstacle O is another vehicle and the space recognition unit 130 detects the number plate of the other vehicle from the camera image, the obstacle O is not an object to be cleared by the occupant and is not a target of assistance.

Furthermore, the space recognition unit 130 may detect a person based on the camera image. The state management unit 110 evaluates the detection result, and if accuracy (probability of being a person) of the person detection is high, the probability is evaluated to be low. The reason for this is that, if the object detected as the obstacle O is a person, the person can be expected to leave an obstruction range. The space recognition unit 130 may further detect a face. When the face is detected, there is a high possibility that the person perceives the vehicle 1 and leaves the obstruction range, so that the probability may be evaluated to be lower.

A state management unit 110 evaluates the probability lower in the case of home parking (the garage G is the garage at home) than in the case of not home parking. The reason for this is that, in the case of home parking, even if there is the obstacle O such as the gate door of the garage G, a moving method for the obstacle is determined and assistance is not required in many cases.

The state management unit 110 may store a place at which it has been detected that the obstacle O has been moved upwards and downwards in the storage unit 150, and evaluate the probability low at the place. The object movable upwards and downwards is, for example, an object that is not required to be cleared, such as a gate of a mechanical parking lot or a shutter or a door of the garage G. Therefore, in such a place, it is preferable to make it difficult to provide unnecessary assistance. In addition, in a place where a user gets off the vehicle due to the operation of a machine, the probability added with getting off the vehicle is required to be discounted before evaluation.

The state management unit 110 stores a place where the rotation of the vehicle body of the vehicle 1 is detected in the storage unit 150, and evaluates the probability to be low at the place. The reason for this is that it is necessary to discount the probability added along with getting off the vehicle at a place where an occupant gets off the vehicle to operate a turntable, and it is easy to erroneously recognize the parking position at a place where the vehicle body is rotated, so that it is preferable to make it difficult to perform unnecessary assistance.

If the position where the occupant C has stopped matches the stop position in the history, the state management unit 110 evaluates the probability to be low. The reason for this is that, in a case where an occupant stops at the position in the history, it can be estimated that the occupant does not stop for the purpose of clearing an obstacle, and thus, it is preferable to make it difficult to perform assistance.

When the obstacle O is not detected, the state management unit 110 evaluates the probability lower than that when the obstacle O is detected. The reason for this is that, for example, if an obstacle is detected, there is a high probability that the occupant has gotten off the vehicle to clear the obstacle, whereas if no obstacle is detected, it is suspected that the occupant has gotten off the vehicle to clear the obstacle. However, even in a case where the obstacle O is not detected, in a case where the probability is added due to another factor such as the motion of the occupant and exceeds the threshold value, the assistance in clearing the obstacle is started. Therefore, in a case where the detection means does not detect an interfering obstacle, the start of the notification may be delayed as compared with a case in which the detection means detects the obstacle.

In addition, since the notification in accordance with the position of the obstacle cannot be performed unless the obstacle is detected, the start of the notification may be suspended, the content of the notification may be limited, or the restrained notification may be made. This may be paraphrased as making it difficult to make a notification as to assistance in clearing the obstacle or making it easier to select a restrained notification in a case where the detection means does not detect an interfering obstacle than in a case where the detection means detects an interfering obstacle.

### Illustration of Flow of Evaluation Based on Probability

Hereinafter, a flow of evaluation based on the probability and suspension of start of assistance will be exemplified. Here, a case where a thin object such as an air pump of a bicycle falls down on the floor of the garage G is considered. After the vehicle 1 starts automatic parking, the space recognition unit 130 detects a three-dimensional object at a position where the front camera can photograph the inside of the garage G. In addition, the side sonar detects an obstacle at a position where the inside of the garage can be detected. However, since it is difficult for the space recognition unit 130 to detect an object having a low height and it is difficult for the sonar to detect a thin object, it is assumed that neither the space recognition unit 130 nor the sonar detects the air pump at this time.

The traveling control unit 140 of the parking assistance ECU 100 decelerates the vehicle 1 when the vehicle 1 approaches a position at which the occupant C can visually recognize the inside of the garage G. When the vehicle reaches the position, the notification unit 160 makes a notification for prompting the occupant to confirm the inside of the garage G. Here, when the driver depresses the brake to stop the vehicle 1, the state management unit 110 evaluates the probability and determines the necessity of assistance.

For example, the state management unit 110 additionally adds an evaluation value to the probability when an obstacle is detected, and does not add an evaluation value to the probability when no obstacle is detected. In addition, if the garage G is a garage at home, the evaluation value is additionally added to the probability, and if the garage G is outside home, the evaluation value is not additionally added to the probability. If a time from the notification for prompting confirmation to the brake operation is short, an evaluation value is additionally added to the probability. In addition, with reference to the past parking history stored in the storage unit 150, the probability is subtracted when the number of times the vehicle has stopped in the past near the stop position is equal to or more than a predetermined number of times, and the probability is not subtracted otherwise. In this case, in the case of parking at home, when there is no history of stopping the vehicle at a close position, it is a short time from the notification for prompting the occupant C to confirm the inside of the garage to the depression of the brake, and it is also a short time from the stop of the vehicle 1 to the first getting-off preparation motion, the evaluation values are additionally added to the probability in an overlapping manner and, as such, the summed-up evaluation value of the probability may exceed a threshold value to determine the start of assistance.

In a case where the assistance is started before the occupant gets off the vehicle, it is preferable that a notification based on the position of the obstacle is made when the interfering obstacle is detected, and a notification indicating a range where interference is caused is made when the interfering obstacle is not detected. Of course, when an obstacle is detected, the range where interference is caused and the position of the obstacle may be notified together. The notification is made, for example, by display on a navigation screen. Then, the occupant can know where to move the obstacle before getting off the vehicle. The notification on the navigation screen is preferably continued even after the occupant gets off the vehicle. The reason for this is that, if the information is displayed on the navigation screen, another occupant remaining in the vehicle can see the information and notify the occupant who has gotten off the vehicle of the information.

When there is no detection of an obstacle at the time when it is determined to start the assistance, possible assistance may be started even if the position of the obstacle is unknown. However, only an advance notice of the assistance may be notified, and the start of the notification may be suspended. The notice of the assistance may be a restrained notification in which only a message is displayed on the screen.

When assistance is performed but no obstacle is detected, the occupant who has gotten off the vehicle may be detected, and assistance may be performed according to the detection result. For example, the state management unit 110 may instruct the space recognition unit 130 to track the occupant C who has gotten off the vehicle, and may estimate that there is an obstacle in the obstruction range if the position where the occupant has stopped is within the parking obstruction range or the getting-off obstruction range. Therefore, when the position at which the occupant C has stopped is within the obstruction range, an evaluation value is further additionally added to the probability, and when the summed-up evaluation value of the probability exceeds the second threshold value, the assistance accompanied by voice may be started. For example, when the occupant C stops and picks up the air pump, the occupant C may be notified that “the obstruction range is reached”, and when the occupant C goes out of the range where interference is caused, the occupant C may be notified that “the occupant C has left the obstruction range” by voice. In addition, in a case where the air pump is detected as a three-dimensional object when the occupant C places the air pump upright, a determination target as to whether or not it interferes may be switched from the occupant C to the three-dimensional object. Furthermore, the face of the occupant may be continuously detected, and when the face of the occupant is detected, that is, when the occupant faces the vehicle 1, it may be determined whether or not the position of the determination target (air pump) is a position causing hindrance of vehicle parking or getting-off the vehicle, and the occupant C may be notified of the determination result.

That is, even if there is no detection of an obstacle, the state management unit 110 may assist the occupant C by estimating that the occupant C has gotten off the vehicle to clear an obstacle if the probability of evaluation from other evaluation factors is high. The state management unit 110 evaluates the probability in this manner and determines whether to provide assistance or not, thereby making it possible to increase the probability of providing assistance when assistance is necessary and the probability of not providing assistance when assistance is unnecessary.

### Processing of Parking Assistance ECU

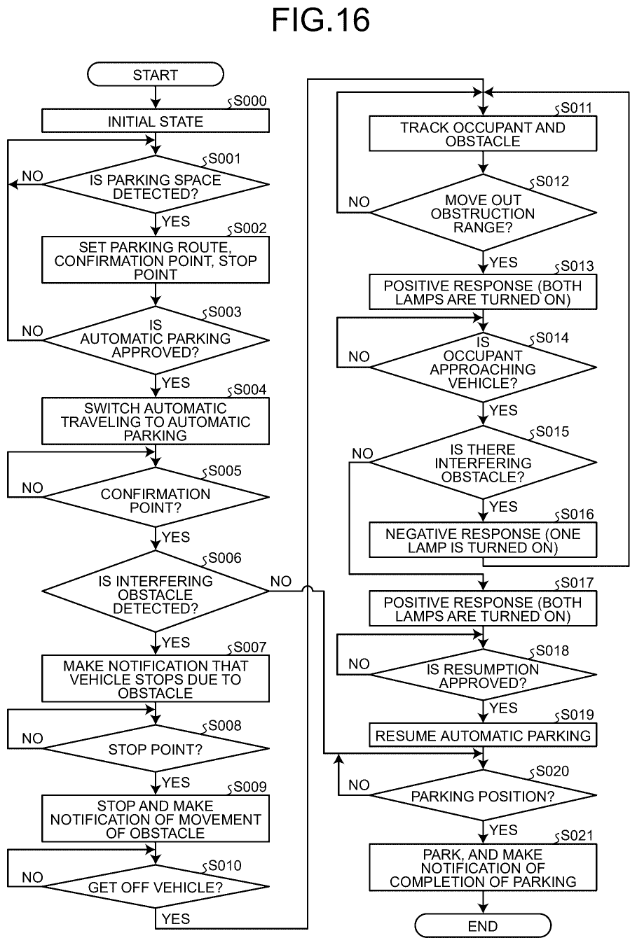

Next, processing executed by the parking assistance ECU 100 will be described with reference to a flowchart of FIG. 16. FIG. 16 is an example of processing executed by the parking assistance ECU 100.

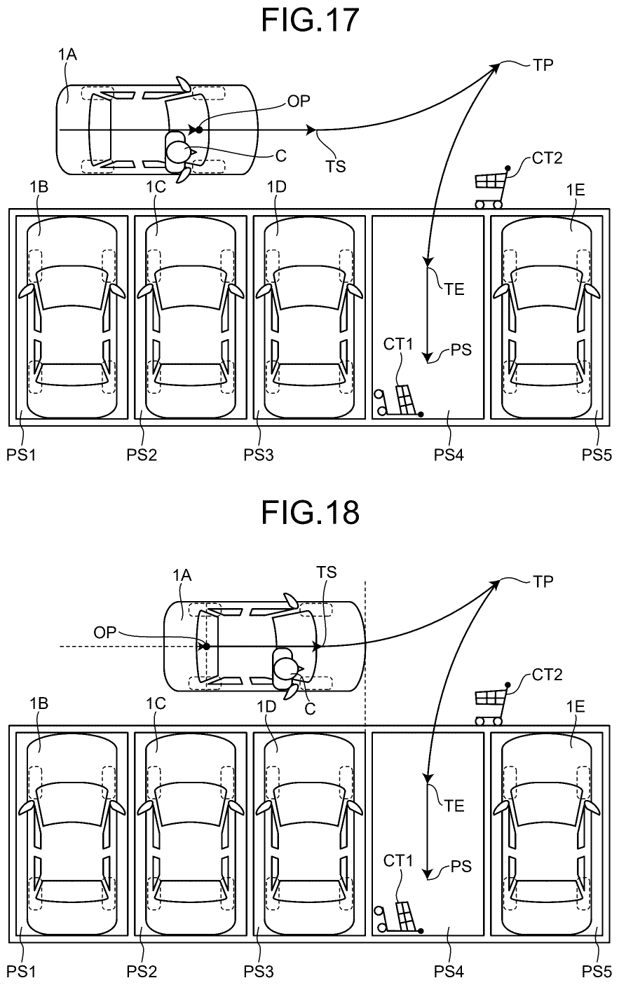

FIGS. 17 to 27 are diagrams each illustrating an example of automatic parking by the parking assistance ECU 100 according to the embodiment. In the initial state (Step S000) of the flowchart of FIG. 16, a vehicle 1A performs automatic traveling on a passage of the parking lot under the control of the traveling control unit 140, and the space recognition unit 130 executes parking space detection processing. That is, a parking assistance function of the parking assistance ECU 100 of the vehicle 1A operates in the automatic traveling mode in which the vehicle autonomously travels for the purpose of searching for a parking space.

Specifically, in the initial state, the vehicle 1 is at the position of the vehicle 1A in FIG. 17, and the space recognition unit 130 detects the angle and the distance of the vehicle body relative to a passage (white line) while detecting an available parking space, and the traveling control unit 140 causes the vehicle 1 to perform automatic traveling so as to maintain a distance to the white line (Step S000). Here, a result of the parking space detection is evaluated (Step S001), and when no available parking space is detected (Step S001: No), the processing returns to Step S001.

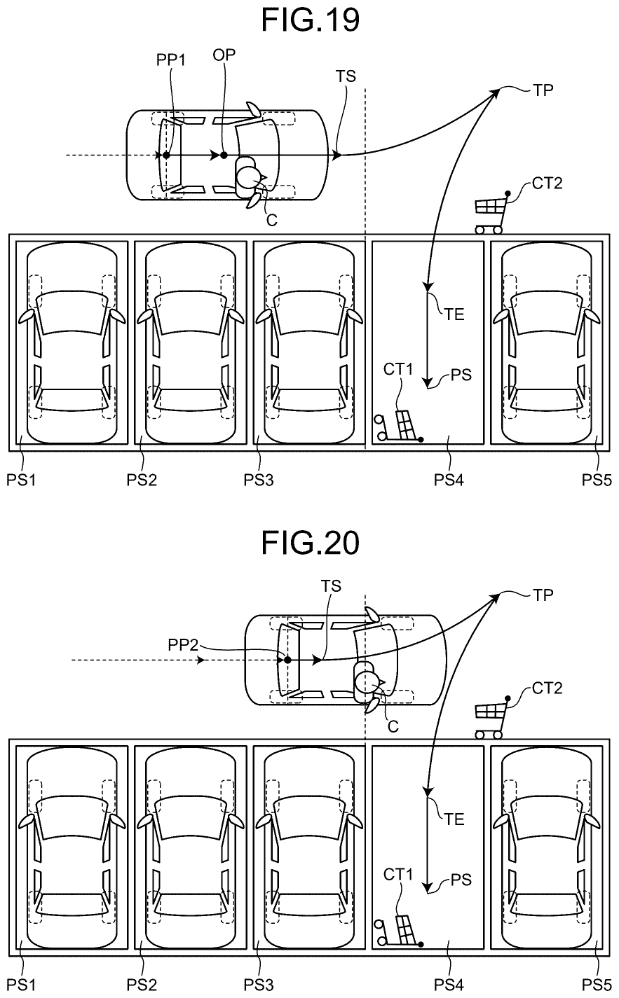

When the available parking space is detected (Step S001: Yes), the state management unit 110 sets a parking route (route stopping at PS through OP, TP, and TE in order) as indicated by an arrow in FIG. 17, and also sets a confirmation point OP and a stop point PP2 (illustrated in FIG. 20) to be described later (Step S002). Although not illustrated, in Step S002, the notification unit 160 displays the parking route and makes an inquiry to request approval of automatic parking. Next, the state management unit 110 determines whether there is approval of the driver (Step S003). If there is no approval of the driver (Step S003: No), the processing returns to Step S001.

When the driver approves the automatic parking (Step S003: Yes), the state management unit 110 starts the automatic parking of the vehicle 1A. That is, the automatic traveling mode in which the vehicle travels along the passage is switched to the automatic parking mode in which the vehicle travels along the parking route (Step S004). Although not illustrated, the space recognition unit 130 stops the white line detection and the parking space detection in accordance with the mode change, and changes a detection range of the obstacle from a range defined along the passage to a range defined along the parking route.

In FIG. 17, there are parking spaces (PS1, PS2, PS3, and PS5) in which other vehicles (1B to 1E) are parked, but since the parking spaces are irrelevant to the vehicle 1A, a parking space PS4 in which the vehicle 1A is to be parked is also simply referred to as a parking space. As an assumption, there are abandoned carts CT1 and CT2 respectively located inside and outside the parking space. The diagram of the cart is a schematic diagram, and the cart stands at the position of the wheels, not lying down. That is, the carts CT1 and CT2 are left at positions in contact with the white line. It is assumed that the occupant of the vehicle 1A is only a driver (occupant C), and there is no person in the vicinity of the vehicle.

In this example, the parking assistance ECU 100 captures an image in the vicinity of the frontage of the parking space PS4 with the front camera from the position of the vehicle 1A illustrated in FIG. 17, determines that an available parking space has been detected, and starts automatic parking. That is, automatic parking is started at a position where it cannot be confirmed whether there is an obstacle in or around the parking space PS4. Therefore, the state management unit 110 sets a confirmation point OP for confirming whether there is no obstacle on the parking route. As illustrated in FIG. 18, the confirmation point OP is a point where the front camera of the vehicle 1A is located on the extension line of the long side on the front side of the parking space and captures the entire parking space. In addition, the position of the obstacle CT2 around the parking space can be more accurately identified by detecting the obstacle CT2 from the vicinity of the vehicle.

The description returns to FIG. 16. The state management unit 110 determines whether the vehicle 1A has reached the confirmation point OP (Step S005). When the vehicle 1A has not reached the confirmation point OP (Step S005: No), the processing returns to Step S005.

As illustrated in FIG. 18, when the vehicle 1A reaches the confirmation point OP (Step S005: Yes), the state management unit 110 determines the presence or absence of an interfering obstacle based on the image captured by the front camera (Step S006). When there is no interfering obstacle (Step S006: No), the processing proceeds to Step S020.

When the interfering obstacle is detected (Step S006: Yes), the notification unit 160 notifies that “the vehicle stops due to presence of the obstacle” (Step S007).

Next, the state management unit 110 determines whether the vehicle 1A has reached the stop point PP2 (Step S008). As illustrated in FIG. 20, the stop position PP2 is a position where the head of the occupant C is located on the extension of the long side on the front side of the parking space and the entire parking space can be visually recognized. When the vehicle 1A has not reached the stop point PP2 (Step S008: No), the processing returns to Step S008.

When the vehicle 1A reaches the stop point PP2 (Step S008: Yes), the traveling control unit 140 stops the vehicle 1A at the stop point PP2 (Step S009). That is, the vehicle does not stop at the time when the obstacle is detected, and stops after traveling to a position where the occupant C can visually recognize the entire parking space. Then, the notification unit 160 notifies the occupant C of movement of the obstacle.

If the vehicle 1 is stopped at the time when an interfering obstacle is detected, the vehicle 1 stops at a location where the obstacle CT2 on the passage is detected. Therefore, for example, as illustrated in FIG. 19, the vehicle 1 may stop at a position PP1 where the obstacle CT1 inside the parking space cannot be detected.

In this case, since the parking assistance ECU 100 detects only the obstacle CT2 on the passage, the occupant C cannot receive assistance based on the detection for the obstacle CT1 inside the parking space. As a result, the occupant C may miss the obstacle CT1 inside the parking space, may return to the vehicle 1A, may resume automatic parking, and then may detect the obstacle CT1 again. That is, since the obstacle is not limited to the first detected object, the vehicle 1 should be stopped after reaching the position where all the obstacles can be detected.

Further, as in the position OP of FIG. 18, the inside of the parking space can be detected by the front camera, but there is also a problem in the position where the obstacle CT1 inside the parking space cannot be seen from the occupant C. Even if the notification unit 160 notifies the occupant of the obstacle CT2 and the obstacle CT1 at this position, the occupant C may only listen to half of the notification before getting out of the vehicle, may clear only the obstacle CT2 that has been seen from the driver's seat, and then may return to the vehicle 1. In this case, the notification unit may make a notification indicating that the obstacle CT2 has not been cleared. As illustrated in FIG. 20, it is more efficient and takes less time to stop the vehicle 1A at a position where the occupant C can see the entire parking route than such a position, thereby notifying the occupant C of all the obstacles, and allowing the occupant to get off the vehicle at one time so as to clear all the obstacles.

Therefore, in the present embodiment, as illustrated in FIG. 20, the state management unit 110 sets the stop position PP2 at a position where the inside of the parking space can be viewed.

In the case of normal parking which is not the automatic parking, a driver starts turning of the vehicle after viewing the inside of the parking space, and performs rearward parking in the parking space. That is, when the vehicle stop position PP2 is set under the above condition, the vehicle stop position PP2 is located before a turning start point TS.

Further, the state management unit 110 may set the stop position PP2 at any position between a position at which the head of the occupant C is located on the extension line of the long side on the front side of the parking space and the turning start point TS. In this case, since the vehicle 1A does not start turning when the vehicle stops and does not obstruct the passage of other vehicles, the occupant C can start clearing an obstacle without hesitation.

That is, as conditions of the stop position suitable for clearing an interfering obstacle, there are three conditions that the long side of a vehicle is substantially parallel to the direction of the road or the passage in a state in which turning of the vehicle is not started, a detection means can detect the parking position, and an occupant can visually recognize the parking position. Although a position that meets all of the conditions is the most suitable position, a position that meets at least one of the conditions is more suitable for clearing an obstacle than a position that does not meet at least one of the conditions. For example, even if the occupant cannot visually recognize the parking position, there is a high possibility that the occupant can be guided to an obstacle if the detection means can detect the obstacle. Even if the obstacle cannot be detected from the stop position of the vehicle, the position of the obstacle may be stored, and if the occupant can visually recognize the obstacle at the parking position, there is a high possibility that the obstacle can be cleared by the occupant. Even if the vehicle obliquely blocks the road, if the occupant can be guided to the obstacle and clear the obstacle in a short time, there is a high possibility that other traveling vehicles are not obstructed by the vehicle. In this manner, all of the conditions are not essential, and it is better to satisfy more conditions.

Returning to the time point when the obstacle is detected, the notification will be described. When the space recognition unit 130 detects an obstacle, the state management unit 110 determines whether the obstacle is within an obstruction range that prevents parking of the vehicle or prevents an occupant from getting off the vehicle. When the determination is Yes (Step S006: Yes), the notification unit 160 makes a notification, for example, indicating that “the vehicle stops due to the obstacle”. However, as described above, the vehicle does not stop at the same time as the notification, but moves to the stop position PP2 and stops there.

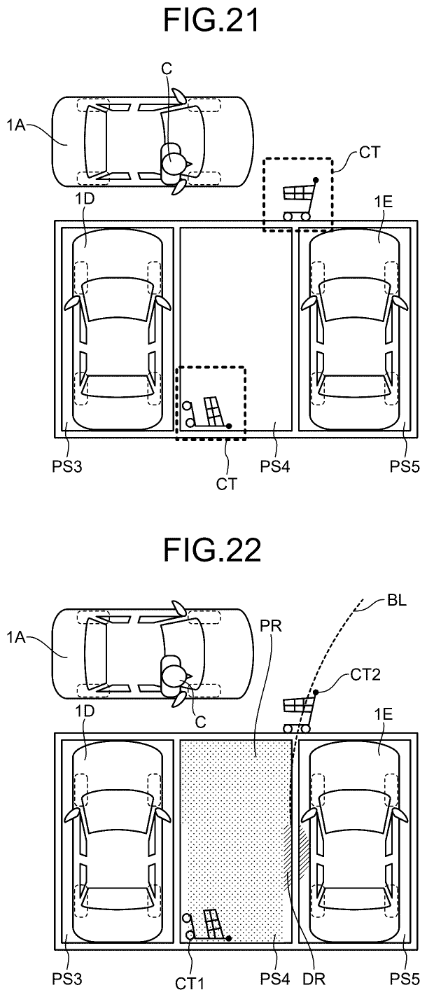

When the vehicle 1A stops, as illustrated in FIG. 21, the notification unit 160 may display the detected obstacles (the Carts CT1 and CT2) each surrounded by a frame and may notify an occupant of each of the detected obstacles as an interfering obstacle. Further, as illustrated in FIG. 22, the notification unit 160 may display a boundary line BL and may display a range where interference is caused. At this time, the notification unit 160 may change a method of displaying the parking obstruction range and the getting-off obstruction range such that the parking obstruction range and the getting-off obstruction range can be distinguished from each other.

FIG. 22 illustrates a range where interference is caused when the driver gets off the vehicle in response to the presence of the occupant C on the driver's seat. When the state management unit 110 inquires of the driver about whether to switch to remote parking, the notification unit 160 may blink the getting-off obstruction range DR, and when the answer is Yes, the display of the getting-off obstruction range DR may be turned off.

The parking obstruction range TR may be displayed as a plane like hatching in FIG. 22, may be displayed as the boundary line BL between an obstruction range and a non-obstruction range like a dotted line in FIG. 22, or both may be used in combination.

When displaying the boundary line BL, the notification unit 160 may display only a boundary line overlapping an obstacle or a boundary line close to the obstacle. In addition, the notification unit 160 may notify a moving destination and a moving distance of the obstacle. In this case, since the space recognition unit 130 has detected the parking space, the notification unit 160 may make a notification with reference to the parking space and may make a notification such as “please move an obstacle out of the parking space”.

Referring back to FIG. 16, the description will be continued. After Step S009, the state management unit 110 determines whether the occupant C gets off the vehicle (Step S010). When the occupant C has not gotten off the vehicle (Step S010: No), the processing returns to Step S010.

When the occupant C has gotten off the vehicle 1A (Step S010: Yes), assistance in clearing the obstacle is started. The space recognition unit 130 tracks the occupant C and the obstacles (the Carts CT1 and CT2) (Step S011).

Next, the state management unit 110 determines whether both the occupant C and the obstacles have been moved out of the parking obstruction range PR (Step S012). When at least one of the occupant C and the obstacles is not moved out of the parking obstruction range PR (Step S012: No), the processing returns to Step S011.

Although not illustrated, a step of determining the direction of the face of the occupant C and a step of notifying whether or not the occupant has left the parking obstruction range PR may be inserted into a loop of repeating Step S012. For example, when the face of the occupant is oriented toward the vehicle, if the occupant is in the parking obstruction range, a negative response is notified, and if the occupant is out of the range, a positive response is notified. In this way, the occupant can know whether the occupant is in or out of the parking obstruction range only by looking at the vehicle.

When the parking assistance ECU 100 assists the occupant C who has gotten off the vehicle, the state management unit 110 may perform the assistance by communication using light or voice. For example, the state management unit 110 may control the notification unit 160 so as to notify the occupant C in advance of a rule (code) indicating that the response is Yes (positive response) when both the left and right lamps (LF, RF, LB, and RB) of the vehicle 1A are turned on and the response is No (negative response) when only one of the left and right lamps is turned on, and may respond to the motion of the occupant C with the lamps. In addition, the occupant C may be notified of a code of an audio notification in advance, and may respond by audio. For example, the response is Yes (positive response) when the machine sound is emitted twice “fan fan”, and the response is No (negative response) when the machine sound is emitted once “fan”.

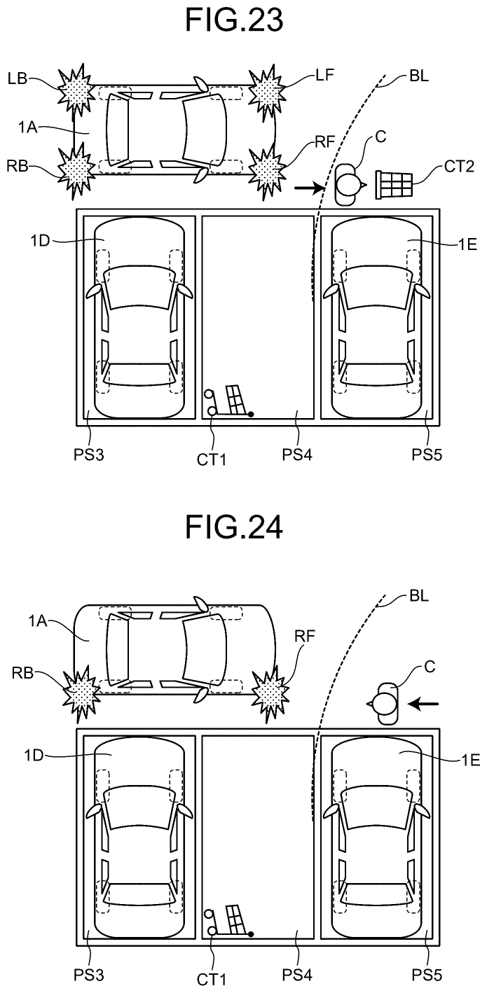

When the occupant C has left the parking obstruction range PR together with the obstacle (the cart CT2) (Step S012: Yes), the notification unit 160 makes a notification indicating that the obstacle has been moved out of the parking obstruction range PR by turning on both lamps (LF, RF, LB, and RB) as a positive response, as illustrated in FIG. 23 (Step S013). At this time, the audio notification (for example, the machine sound is emitted twice “fan fan”) may be performed at the same time such that the occupant C can recognize even if the occupant C turns his/her back to the vehicle 1A.

Next, the state management unit 110 determines whether the occupant C is approaching the vehicle 1A (Step S014). When the occupant C is not approaching the vehicle 1A (Step S014: No), the processing returns to Step S014.

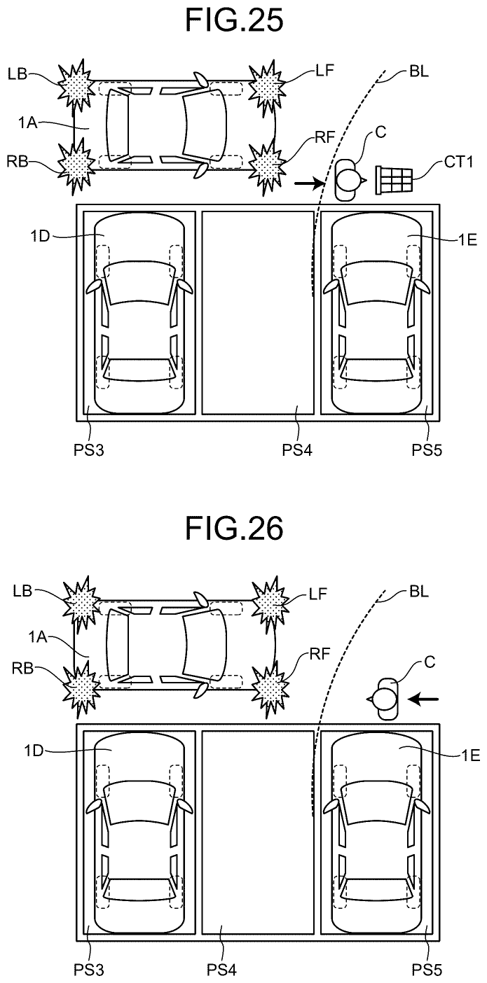

When the occupant C is approaching the vehicle 1A (Step S014: Yes), the state management unit 110 determines whether there is an interfering obstacle (Step S015). As illustrated in FIG. 26, when there is no interfering obstacle (Step S015: No), the processing proceeds to Step S017.

The reason why the determination conditions are different between step 12 and step 15 is that the purpose of the notification is different. The detection means may detect the direction of the face or the head of the occupant or the movement direction of the occupant, and when the movement direction is a direction away from the vehicle, the detection unit may inform whether the movement of the occupant is sufficient. Therefore, the notification means makes a notification indicating whether or not the occupant has left the obstruction range. When the occupant turns toward the vehicle after leaving the obstruction range, the notification unit may inform whether the automatic parking can be resumed. Therefore, the notification means makes a notification indicating whether or not there is an interfering obstacle within the obstruction range.

The description of Step S015 will be continued. As illustrated in FIG. 24, if there is an obstacle interfering when the occupant C approaches the vehicle 1A, the processing proceeds to Step S016 (Step S015: Yes). For example, as illustrated in FIG. 24, when the interfering obstacle (the cart CT1) is present on the right of the vehicle 1A, the notification unit 160 notifies the occupant of a negative response by turning on only the right lamp (RF and RB), and makes a notification indicating that the automatic parking cannot be resumed (Step S016). At this time, the notification unit 160 turns on the right lamp (RF and RB) to make a notification indicating that the interfering obstacle (the cart CT1) is present on the right of the vehicle 1A. Thereafter, the processing returns to Step S011. In the negative response at this time, a negative response by “fan” emitted once may be used together, or “an obstacle is present in the parking space” may be announced by voice.

After returning to Step S011, as illustrated in FIG. 25, when the obstacle (the cart CT1 in the parking lot) has been moved out of the parking obstruction range PR (Step S012: Yes), the notification unit 160 notifies the occupant of a positive response (Step S013). Subsequently, as illustrated in FIG. 26, when the occupant C approaches the vehicle 1A in a state in which there is no interfering obstacle (Step S014: Yes, Step S015: No), the notification unit 160 notifies a positive response by turning on both lamps and notifies that automatic parking can be resumed (Step S017). Thereafter, the processing proceeds to Step S018. As for the positive response at this time, a positive response by “fan fan” emitted twice may be used together as a machine sound, or “automatic parking can be resumed” may be announced by voice.

Here, an example of the notification by the lamp or the speaker of the vehicle 1 has been introduced, but the notification may be performed by vibrating a terminal (for example, a smart key or a mobile phone) carried by the occupant C or emitting a sound from the terminal. At that time, it is possible to avoid misunderstanding by making a rule of a code common (for example, twice in the case of Yes, and once in the case of No) regardless of the terminal.

When assisting the occupant who has gotten off the vehicle, the parking assistance ECU 100 may cause the detection unit to detect the direction of the face or head of the occupant who has gotten off the vehicle or the movement of the occupant, and may change a means of making a notification depending on the direction thereof. For example, the means of making a notification may be made different between a case in which the direction of the face or head of the occupant or the movement direction of the occupant is a direction away from the vehicle and a case in which the direction of the face or head of the occupant or the movement direction of the occupant is a direction toward the vehicle or the movement of the occupant is stopped. In a case where the direction of the face or head of the occupant or the movement direction of the occupant is the direction away from the vehicle, the notification may be made by using a means including at least one of voice or vibration of a terminal carried by the occupant, and in a case where the direction of the face or head of the occupant or the movement direction of the occupant is the direction toward the vehicle or the movement of the occupant is stopped, the notification may be made by using a means including a light of the vehicle.

Referring back to FIG. 16, the description will be continued. When all the interfering obstacles are cleared (Step S015: No), the notification unit 160 makes a notification indicating that automatic parking can be resumed in the positive response (Step S017). Although not illustrated, at the time of the positive response, a notification as to inquiry about resumption of automatic parking is also made. For example, the notification unit 160 may cause the HMI device 20 (for example, the navigation screen) to display a message inquiring about the resumption of the automatic parking, or may transmit a signal to a terminal carried by the occupant C to output the message for inquiry about the resumption of the automatic parking through the terminal. The message for inquiry about the resumption may be outputted by, for example, a code such as three times of vibration. In a case where the notification is made by a mobile terminal, the positive response may be omitted, and only a message for inquiry about the resumption may be output.

After the inquiry, the state management unit 110 determines whether the resumption is approved by the occupant C (Step S018). For example, the occupant C may return to the driver's seat and may input Yes with respect to the message “do you want to resume automatic parking?” displayed on the navigation screen, thereby giving an instruction to resume automatic parking. Alternatively, the occupant C may give an instruction to resume automatic parking without returning to the driver's seat by operating the mobile terminal. When the resumption is not approved (Step S018: No), the processing returns to Step S018.

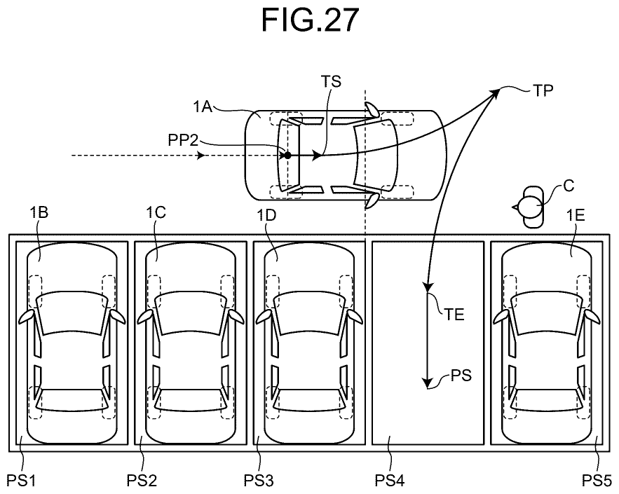

Upon receiving the instruction to resume automatic parking (S018: Yes), as illustrated in FIG. 27, the state management unit 110 resumes the automatic parking (Step S019). FIG. 27 illustrates a case in which the occupant C approves the resumption of the automatic parking without returning to the driver's seat. The traveling control unit 140 causes the vehicle 1A to travel toward the parking position PS, and the state management unit 110 determines whether the vehicle 1A has reached the parking position PS (Step S020).

When the vehicle 1A has not reached the parking position PS (Step S020: No), the processing returns to Step S020. When the vehicle 1A reaches the parking position PS (Step S020: Yes), the traveling control unit 140 parks the vehicle 1A at the parking position PS, the notification unit 160 notifies the completion of parking, and then the state management unit 110 ends all the functions of the parking assistance device (Step S021).

According to the present disclosure, it is possible to improve convenience of a parking assistance device.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A parking assistance device configured to automatically park a vehicle at a predetermined parking position, the parking assistance device comprising:
a memory; and
a processor coupled to the memory and configured to:
store a parking route to the parking position;
perform detection at least around the vehicle to obtain detection information;
control traveling in automatic parking;
make a notification to an occupant of the vehicle; and
suspend, based on at least one of the detection information and a motion of the occupant, the traveling in the automatic parking, wherein
the processor is configured to:
suspend the traveling in the automatic parking in at least one of a case in which the processor detects an obstacle interfering during the automatic parking and a case in which the occupant stops the vehicle, and
make a notification as to suspension of the traveling of the automatic parking, to the occupant.

2. The parking assistance device according to claim 1, wherein
the processor is configured to, when detecting the interfering obstacle, suspend the traveling of the automatic parking at a predetermined position, and
the predetermined position is a position corresponding to at least one of:
a position at which a long side of the vehicle is substantially parallel to a direction of a road or a passage;
a position enabling the processor to detect the parking position; and
a position enabling the occupant to visually recognize the parking position.

3. The parking assistance device according to claim 1, wherein
the processor is configured to,
when a direction of the vehicle is substantially parallel to a road and
the occupant is capable of visually recognizing the parking position,
perform at least one of making a notification of requesting confirmation of the parking position and decelerating the vehicle.

4. The parking assistance device according to claim 1, wherein
the processor is configured to,
when the occupant stops the vehicle,
suspending the traveling of the automatic parking,
when detecting the interfering obstacle, or
when the occupant performs a getting-off preparation action.

5. The parking assistance device according to claim 1, wherein
the interfering obstacle is an obstacle present in an obstruction range,
the obstruction range is a range corresponding to at least one of a parking obstruction range and a getting-off obstruction range, a closest distance to the vehicle body from the parking obstruction range being equal to or less than a margin threshold value during the automatic parking, a distance to a vehicle door from the getting-off obstruction range being equal to or less than a getting-off room threshold value when the occupant gets off the vehicle, and
the processor is configured to determine, based on a positional relationship between a position of the detected obstacle and the obstruction range, whether the obstacle is the interfering obstacle.

6. The parking assistance device according to claim 5, wherein
the processor is further configured to detect seating of the occupant, and
the processor is configured to set the getting-off obstruction range corresponding to a seat on which the occupant is seated, and not to set the getting-off obstruction range for a seat on which the occupant is not seated.

7. The parking assistance device according to claim 5, wherein
the processor is further configured to detect a location of a smart key, and
the processor is configured to set the getting-off obstruction range corresponding to a driver's seat when the smart key is inside the vehicle, and not to set the getting-off obstruction range corresponding to the driver's seat when the smart key is outside the vehicle.

8. The parking assistance device according to claim 5, wherein
the processor is configured to set at least one of the margin threshold value and the getting-off room threshold value in accordance with at least one of whether a side mirror is open or closed, and an environmental condition, and
the environmental condition includes at least one of an inclination of the vehicle body, a vibration of the vehicle body, a temperature outside the vehicle, and a wind speed outside the vehicle.

9. The parking assistance device according to claim 5, wherein
the processor is configured to,
when an obstacle is present in the getting-off obstruction range and no obstacle is present in the parking obstruction range,
make at least one of:
a notification regarding the occupant being obstructed from getting off the vehicle by the obstacle;
a notification indicating that the traveling of the automatic parking is startable when the occupant gets off the vehicle;
a notification suggesting the occupant to get off the vehicle; and
a notification as to a means allowing the traveling of the automatic parking to be started from an outside of the vehicle.

10. The parking assistance device according to claim 1, wherein
the processor is configured to make at least one of:
a notification indicating a range in which the obstacle interferes when being present when the automatic parking is performed or the occupant gets off the vehicle;
a notification indicating the interfering obstacle,
a notification indicating a position at which the interfering obstacle is to be cleared;
a notification indicating a movement distance causing the interfering obstacle not to interfere;
a notification reporting presence or absence of the interfering obstacle;
a notification reporting a direction of the interfering obstacle; and
a notification reporting that the obstacle no longer interferes.

11. The parking assistance device according to claim 1, wherein
the processor is configured to,
when not detecting the interfering obstacle,
make it more difficult to make the notification or make it easier to select a restrained notification than
when detecting the interfering obstacle.

12. The parking assistance device according to claim 1, wherein
the processor is configured to,
when not detecting the interfering obstacle,
detect the occupant going outside the vehicle, and
make the notification by regarding a position of the occupant as a position of the interfering obstacle.

13. The parking assistance device according to claim 1, wherein
the processor is configured to
when not detecting the interfering obstacle, make a notification indicating a range where interference is caused when the obstacle is present during the automatic parking or when the occupant gets off the vehicle, and
when detecting the interfering obstacle, make a notification based on a position of the obstacle.

14. The parking assistance device according to claim 1, wherein
the processor is configured to:
evaluate a probability that the notification is required; and
perform, based on the probability, at least one of a selection of whether or not to make the notification and a selection of a mode of the notification,
the selection of whether or not to make the notification is a selection of making the notification when the probability is high and not making the notification when the probability is low, and
the selection of the mode of the notification is a selection of making an active notification when the probability is high and making a restrained notification when the probability is low.

15. The parking assistance device according to claim 14, wherein
the processor is configured to evaluate the probability based on at least one of a motion of the occupant, a detection result of performing the detection at least around the vehicle, position information, and a history of past parking, and
the processor is configured to perform at least one of:
an evaluation of making the probability higher when a time from stoppage of the vehicle to a motion of preparing getting-off the vehicle is shorter than when the time is longer;
an evaluation of making the probability higher when a position of the obstacle is closer to the parking route than when the position of the obstacle is farther from the parking route;
an evaluation of making the probability higher when the obstacle is detected than when the obstacle is not detected;
an evaluation of making the probability lower when the obstacle is a person than when the obstacle is not the person;
an evaluation of making the probability lower when the parking position is a garage at home than when the parking position is not the garage at home; and
an evaluation of determining whether a place at which the occupant has stopped outside the vehicle substantially coincides with a place at which the occupant stopped recorded in the history, and making the probability lower when they substantially coincide with each other than when they substantially do not coincide with each other.

16. The parking assistance device according to claim 1, wherein the processor is configured to:
detect a direction of a face of the occupant going outside the vehicle or a position of the occupant; and
make a notification based on the position of the occupant,
when the position of the occupant is changed from within a range where interference is caused when the obstacle is present, to outside the range,
when a speed at which the position of the occupant moves away from the vehicle decreases, or
when the face of the occupant is oriented toward the vehicle.

17. The parking assistance device according to claim 1, wherein
the processor is configured to:
detect at least one of a direction of a face of the occupant going outside the vehicle or a movement direction of the occupant; and
change a mode of the notification between when the direction of the face or the movement direction is a direction away from the vehicle and when the direction of the face or the movement direction is a direction toward the vehicle,
a mode of the notification made when the direction of the face or the movement direction is the direction away from the vehicle is a notification including at least one of a voice or a vibration of a terminal carried by the occupant, and
a mode of the notification performed when the direction of the face or the movement direction is the direction toward the vehicle is a notification including control of a light of the vehicle.

18. The parking assistance device according to claim 1, wherein
the processor is configured to:
detect at least one of a direction of a face of the occupant going outside the vehicle or a movement direction of the occupant; and
change a content of the notification between when the direction of the face or the movement direction is a direction away from the vehicle and when the direction of the face or the movement direction is a direction toward the vehicle.

19. A parking assistance method using a parking assistance device including a memory, and a processor coupled to the memory and configured to store a parking route to a predetermined parking position, the parking assistance device automatically parking a vehicle at the parking position, the parking assistance method comprising:
performing detection at least around the vehicle to obtain detection information;
controlling traveling in automatic parking;
making a notification to an occupant of the vehicle; and
suspending, based on at least one of the detection information and an operation of the occupant, the traveling of the automatic parking, wherein
in the suspending, the traveling of the automatic parking is suspended in at least one of a case in which an obstacle interfering during the automatic parking is detected in the performing the detection and a case in which the occupant stops the vehicle, and
in the making the notification, the notification as to suspension of the traveling of the automatic parking is made to the occupant.

20. The parking assistance method according to claim 19, wherein
in the suspending,
the traveling of the automatic parking is suspended at a predetermined position when the interfering obstacle is detected in the performing the detection, and
the predetermined position is a position corresponding to at least one of:
a position at which a long side of the vehicle is substantially parallel to a direction of a road or a passage,
a position at which the parking position is detectable in the performing the detection, and
a position enabling the occupant to visually recognize the parking position.
